(19) United States
(12) Patent Application Publication
(10) Pub. No.: US 2004/0104868 A1
(43) Pub. Date: Jun. 3, 2004

(54) Display device having a plurality of discharge cells in each unit light-emitting area

(75) Inventors: Hiroyuki Ajiki, Yamanashi-ken (JP); Nobuhiko Saegusa, Yamanashi-ken (JP); Kimio Amemiya, Yamanashi-ken (JP); Kazuo Yahagi, Yamanashi-ken (JP); Mitsushi Kitagawa, Fukuroi-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/701,632

(22) Filed: Nov. 6, 2003

(30) Foreign Application Priority Data
Nov. 28, 2002 (JP) 2002-346316

(51) Int. Cl. G09G 3/28

(52) U.S. Cl. 345/60

(57) ABSTRACT

A display device capable of preventing erroneous discharge and improving the quality of display. The display panel has a unit light-emitting area formed at the intersection of row and column electrodes which is structured by a first discharge cell and a second discharge cell having a light absorbing layer at a side close to a front substrate and a secondary-electron emitting material layer at a side close to a back substrate. While applying a scanning pulse having a polarity to place the column electrode in low potential to one row electrode of a row electrode pair, a pixel data pulse having a voltage commensurate with pixel data is applied to the column electrode, thereby selectively causing address discharge within the second discharge cell. With this structure, because the column electrode within the second discharge cell acts as a cathode relative to the row electrode, secondary electrons are to be emitted favorably from the secondary-electron emitting material layer formed within the second discharge cell, thus positively causing address discharge.

### BACKGROUND OF THE INVENTION

1. Technical Field

The present invention relates to a display device mounted with a display panel.

2. Background Art

Recently, attentions are drawn to the plasma display mounted with an alternating-current plasma display panel of surface discharge scheme, as a color display panel that is large in size but small in thickness.

FIGS. 1 to 3 show a part of a conventional structure of alternating-current plasma display panel of surface discharge type. See Japanese Patent Kokai No. 5-205642 (Patent Document 1), for example.

The plasma display panel (PDP) is formed with a structure for causing discharge on each pixel between the parallel-arranged front glass substrate 1 and back glass substrate 4, as shown in FIG. 2. The front glass substrate 1 has a surface to serve as a display surface. The front glass substrate 1 has a back surface, on which provided are a plurality of elongate electrode pairs (X′, Y′), a dielectric layer 2 covering the row electrode pairs (X′, Y′), and a protection layer 3 of MgO (magnesium oxide) covering a back surface of the dielectric layer 2, in the order. Each row electrode X′, Y′is structured by a transparent electrode Xa′, Ya′made by a wide transparent conductive film of ITO or the like and a bus electrode Xb′, Yb′ made by a narrow metal film compensating for a conductivity thereof. The row electrodes X′ and Y′ are alternately arranged vertically on the display screen such that they are opposed at respective sides, to form a discharge gap g′. The row electrode pair (X′, Y′) constitutes one display line (row) L for matrix display. On the back glass substrate 4, there are provided a plurality of column electrodes D′ arranged orthogonally to the row electrode pair X′, Y′, strip-formed partition walls 5 formed parallel between the column electrodes D′ and a fluorescent layer 6 formed of red (R), green (G) and blue (B) fluorescent materials covering the side surface of partition wall 5 and the column electrodes D′, as shown in FIG. 3. Between the protection layer 3 and the fluorescent layer 6, a discharge space S′ exists where an Ne—Xe gas containing xenon is filled, as shown in FIG. 2. On each display line L, a discharge cell C′ as a light-emitting unit area that the discharge space S′ is demarcated at the intersection of the column electrode D′ and the row electrode pair (X′, Y′), as shown in FIG. 1.

In connection with the image formation on the surface-discharge type alternating-current PDP, there is a known grayscale driving scheme using a sub-field technique for display with intermediate tones. In this driving method, the period of one-field display is divided into N sub-fields to assign each of the sub-fields with the number of times of light emissions corresponding to the weighting of that sub-field. According to an input video signal, the discharge cell is set with a sub-field for light emission and a sub-field not for light emission, thus driven to emit light. On this occasion, perception is at intermediate luminance in compliance with the total number of times of light generations throughout one of the fields.

FIG. 4 shows various driving pulses to be applied to the PDP within each sub-field, for realizing the foregoing driving.

As shown in FIG. 4, the sub-field is constituted by a simultaneous reset period Rc, an address period Wc and a sustain period Ic.

In the simultaneous reset period Rc, reset pulses RPx, RPy are simultaneously applied to between the row electrode X₁′-Xₙ′ and Y₁′-Yₙ′ which respectively form pairs, thereby simultaneously causing reset discharge in all the discharge cells. This once forms a predetermined amount of wall charge in each discharge cell. In the next address period Wc, a scanning pulse SP is applied to the row electrodes Y₁′-Yₙ′ in the order, and a pixel data pulse based on each pixel corresponding to the input video signal is applied in an amount of one display line per time to the column electrodes D₁′-Dₘ′. Namely, as shown in FIG. 4, the column electrodes D₁-Dₘ′ are sequentially applied respectively by the pixel data pulse groups DP₁-DPₙ each comprising pixel data pulses in the number of m and corresponding to the first to the n-th display line, synchronously with the scanning pulse SP. On this occasion, address discharge (selective erase discharge) is caused only in the discharge cell applied by a high-voltage pixel data pulse simultaneously with the scanning pulse. By such address discharge, the wall charge formed within the discharge cell is vanished away. Meanwhile, within the discharge cell where address discharge is not caused, the wall charge remains. In the next sustain period Ic, sustain pulses IPx, IPy are applied in the number corresponding to a weighting on each sub-field to between the mating row electrodes X₁′-Xₙ′ and Y₁′-Yₙ′. As a result, only the luminous cell remained with wall charge repeats sustain discharge the number of times corresponding to the number of sustain pulses IPx, IPY applied. Due to such sustain discharge, a vacuum ultraviolet ray having a wavelength 147 nm is emitted from the xenon Xe filled within the discharge space S′. The vacuum ultraviolet ray excites the red (R), green (G) and blue (B) fluorescent layer formed on the back substrate, to generate a visible portion of light.

In the meanwhile, in the case the PDP structured as shown in FIGS. 1 to 3 is driven as shown in FIG. 4, address discharge is possibly not caused correctly in the address period Wc. In the case address discharge is not correctly caused, wall charge cannot be completely vanished away. This results in a problem that correct image display is not available corresponding to an input video signal.

The present invention has been made in order to solve the problem, and it is an object to provide a display device capable of preventing erroneous discharge and improving the quality of display.

### SUMMARY OF THE INVENTION

A display device of the present invention is a display device for carrying out an image display according to pixel data on each pixel on the basis of an input video signal, correspondingly to the input video signal, comprising: a display panel having front and back substrates arranged to sandwich a discharge space; a plurality of row electrode pairs provided on an inner surface of the front substrate; a plurality of column electrodes arranged crossing the row electrode pairs on the inner surface of the back substrate; and

unit light-emitting areas, respectively formed at intersections of the row electrode pairs and the column electrodes, each comprising a first discharge cell and a second discharge cell having a light absorbing layer close to the front substrate and a secondary-electron emitting material layer close to the back substrate; an address component for sequentially applying, while sequentially applying a scanning pulse having a polarity for placing the column electrode in a low potential to first row electrodes of first and second row electrodes constituting the row electrode pairs, a pixel data pulse having a voltage corresponding to the pixel data in an amount of one display line per time to the column electrodes in the same timing as the scanning pulse, thereby selectively causing address discharge within the second discharge cell; and a sustain component for repetitively applying a sustain pulse alternately to the first row electrodes and the second row electrodes.

### BRIEF DESCRIPTION OF THE DRAWINGS

FIG. 1 is a plan view of a part of a conventional PDP structure as viewed from the front;

FIG. 2 is a view showing a section of the PDP on the line V-V shown in FIG. 1;

FIG. 3 is a view showing a section of the PDP on the line W-W shown in FIG. 1;

FIG. 4 is a figure showing various driving pulses to be applied to the PDP and application timing thereof;

FIG. 5 is a diagram showing a schematic configuration of a plasma display device;

FIG. 6 is a plan view of a part of a PDP 50 configuration shown in FIG. 5, as viewed from the front;

FIG. 7 is a view showing a section of the PDP 50 on the line V1-V1 shown in FIG. 6;

FIG. 8 is a view showing a section of the PDP 50 on the line V2-V2 shown in FIG. 6;

FIG. 9 is a view showing a section of the PDP 50 on the line W1-W1 shown in FIG. 6;

FIG. 10 is a figure showing a pixel data converting table to be used in driving adopting a selective write address scheme and a light-emission driving pattern based on the pixel driving data GD obtained by the pixel data converting table;

FIG. 11 is a figure showing an example of light-emission driving sequence in driving adopting a selective write address scheme;

FIG. 12 is a diagram showing the various driving pulses to be applied to the PDP 50 in a head sub-field SF1 according to the light-emission driving sequence shown in FIG. 11 and application timing thereof;

FIG. 13 is a figure showing a pixel data converting table to be used in driving adopting a selective erase address scheme and a light-emission driving pattern based on the pixel driving data GD obtained by the pixel data converting table;

FIG. 14 is a figure showing an example of light-emission driving sequence in driving adopting a selective erase address scheme;

FIG. 15 is a diagram showing the various driving pulses to be applied to the PDP 50 in a head sub-field SF1 according to the light-emission driving sequence shown in FIG. 14, and application timing thereof;

FIG. 16 is a diagram showing another configuration of plasma display device mounted with a PDP 500;

FIG. 17 is a plan view of a part of a PDP 500 structure as viewed from the front;

FIG. 18 is a view showing a section of the PDP 500 on the line V1-V1 shown in FIG. 17;

FIG. 19 is a view showing a section of the PDP 500 on the line V2-V2 shown in FIG. 17;

FIG. 20 is a view showing a section of the PDP 500 on the line W1-W1 shown in FIG. 17;

FIG. 21 is a diagram showing the various driving pulses to be applied to the PDP 500 in a head sub-field SF1 in driving adopting a selective write address scheme, and application timing thereof;

FIG. 22 is a diagram showing the various driving pulses to be applied to the PDP 500 in a head sub-field SF1 in driving adopting a selective erase address scheme, and application timing thereof;

FIG. 23 is a diagram showing another configuration of plasma display device;

FIG. 24 is a plan view of a part of a PDP 501 structure shown in FIG. 23, as viewed from the front;

FIG. 25 is a view showing a section of the PDP 501 on the line V1-V1 shown in FIG. 24;

FIG. 26 is a view showing a section of the PDP 501 on the line V2-V2 shown in FIG. 24;

FIG. 27 is a view showing a section of the PDP 501 on the line W1-W1 shown in FIG. 24;

FIG. 28 is a figure showing a pixel data converting table to be used in driving the plasma display device shown in FIG. 23 by adopting a selective write address scheme, and a light-emission driving pattern based on the pixel driving data GD obtained by the pixel data converting table;

FIG. 29 is a figure showing an example of light-emission driving sequence in driving the plasma display device shown in FIG. 23 by adopting a selective write address scheme;

FIG. 30 is a diagram showing the various driving pulses to be applied to the PDP 501 in a head sub-field SF1 according to the light-emission driving sequence shown in FIG. 29, and application timing thereof;

FIG. 31 is a figure showing a pixel data converting table to be used in driving the plasma display device shown in FIG. 23 by adopting a selective erase address scheme, and a light-emission driving pattern based on the pixel driving data GD obtained by the pixel data converting table;

FIG. 32 is a figure showing an example of light-emission driving sequence in driving the plasma display device shown in FIG. 23 by adopting a selective erase address scheme; and

FIG. 33 is a diagram showing the various driving pulses to be applied to the PDP 501 in a head sub-field SF1 according to the light-emission driving sequence shown in FIG. 32, and application timing thereof.

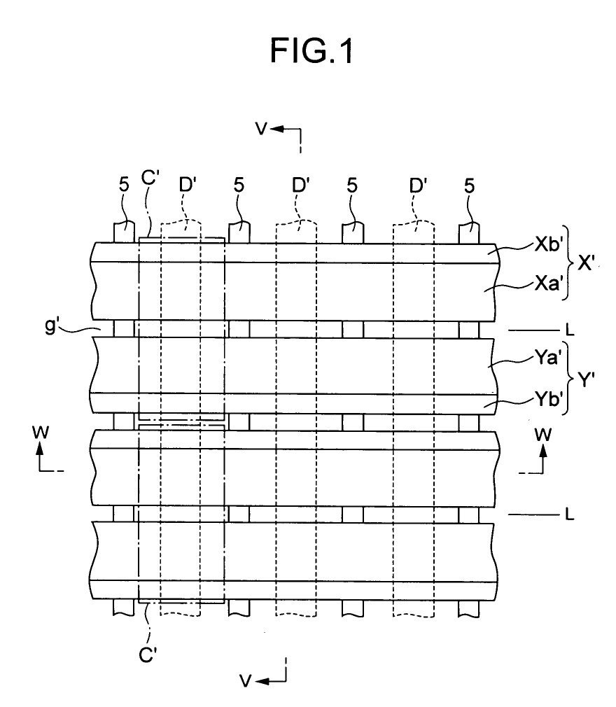

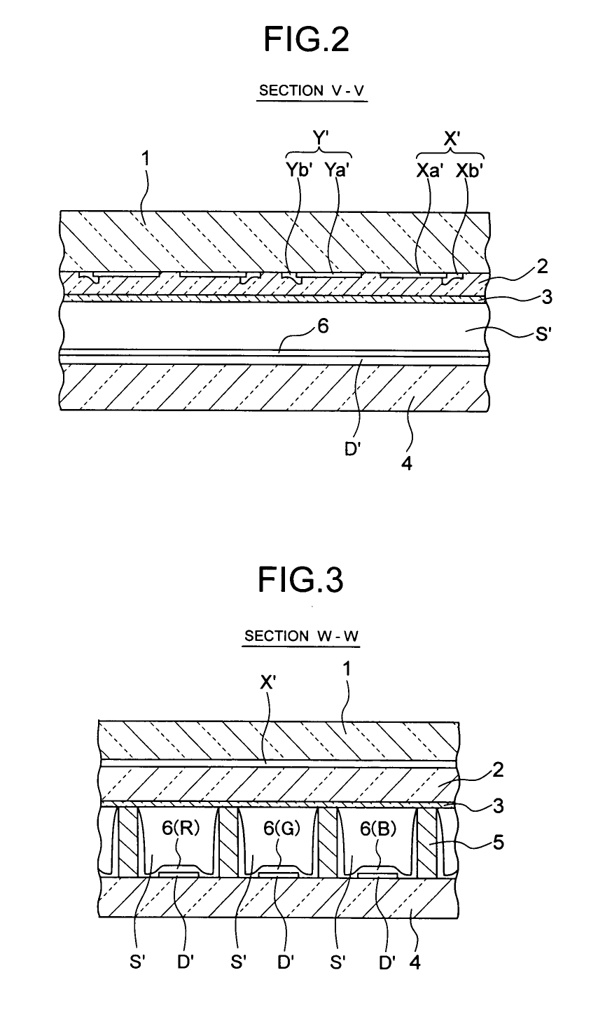

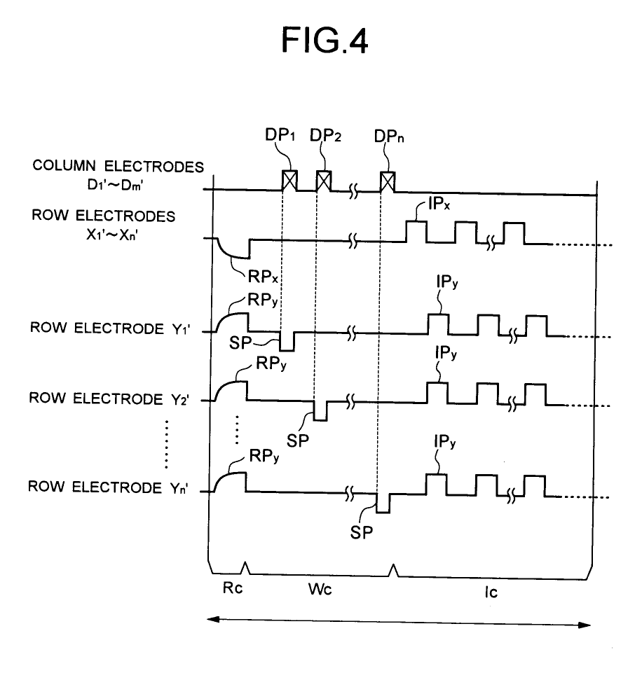

### DETAILED DESCRIPTION OF THE INVENTION

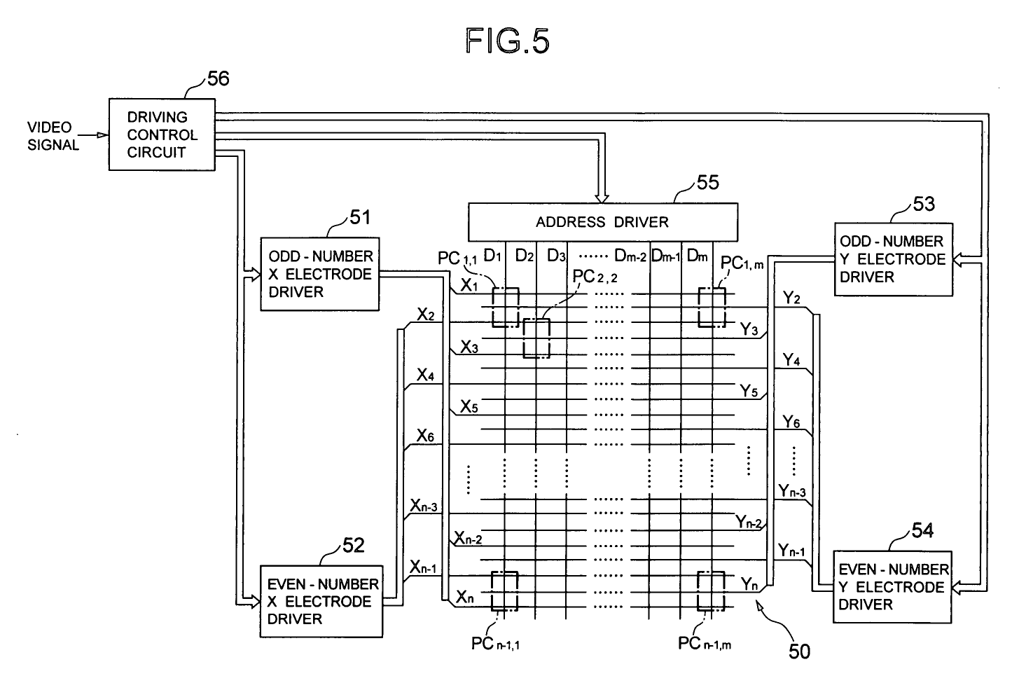

FIG. 5 shows a configuration of a plasma display as a display device according to the present invention.

As shown in FIG. 5, the plasma display device is configured with a PDP 50 as a plasma display panel, an odd-number X electrode driver 51, an even-number X electrode driver 52, an odd-number Y electrode driver 53, an even-number Y electrode driver 54, an address driver 55 and a drive control circuit 56.

The PDP 50 is formed thereon with strip-formed column electrodes D₁-Dₘ extending vertically on a display screen. Furthermore, the PDP 50 is formed thereon with strip-formed row electrodes X₁-Xₙ and row electrodes Y₂-Yₙ extending horizontally on the display screen, which are alternately arranged in the numerical order as shown in FIG. 5. The row electrodes in a pair, i.e. row electrode pair (X₂, Y₂)—row electrode pair (Xₙ, Yₙ), serve as a first to (n−1)-th display line on the PDP 50. Pixel cells PC, serving as pixels, are respectively formed at intersections of the display lines and the column electrodes D₁-Dₘ (in areas surrounded by the one-dot chain line in FIG. 5). Namely, on the PDP 50, arranged are pixel cells PC_{1.1}-PC_{1,m} belonging to the first display line, pixel cells PC_{2.1}-PC_{2,m} belonging to the second display line, . . . , pixel cells PC_{n-1.1}-PC_{n-1,m} belonging to the (n−1)-th display line, in a matrix form.

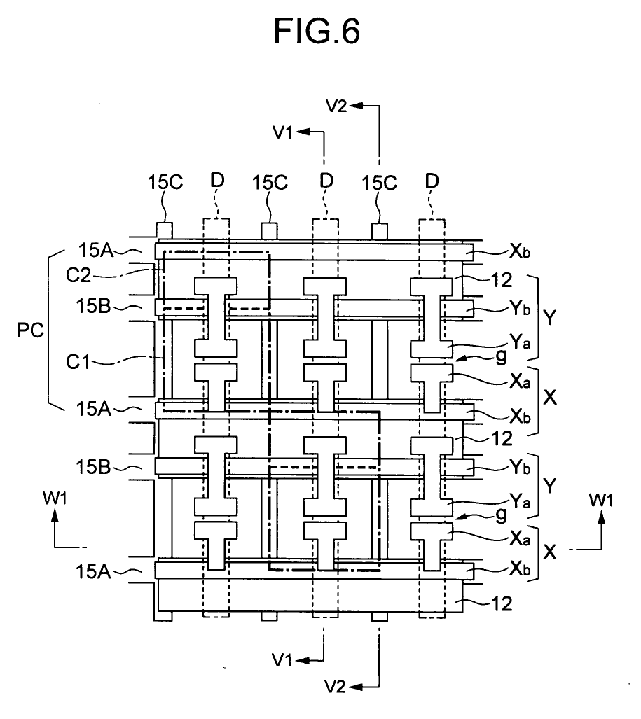

FIGS. 6 to 9 show a part of internal structure of the PDP 50 by excerption.

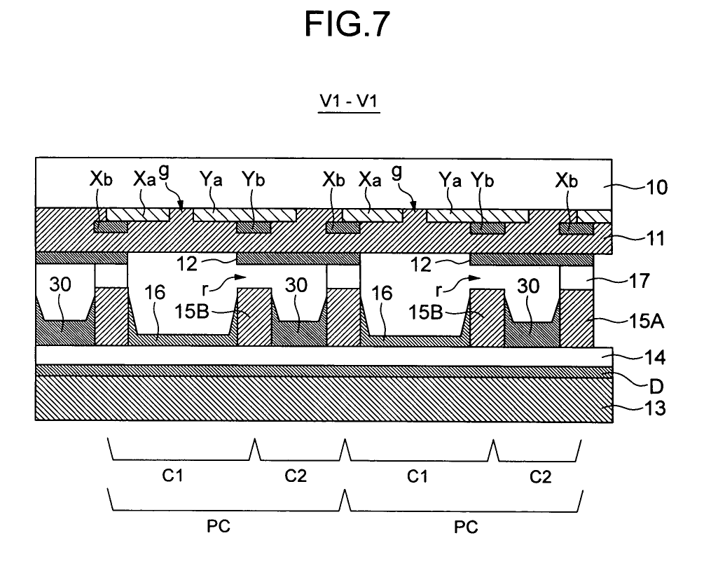

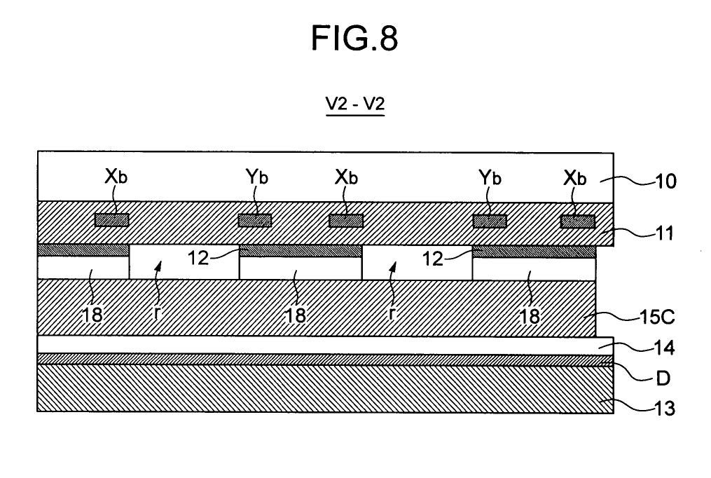

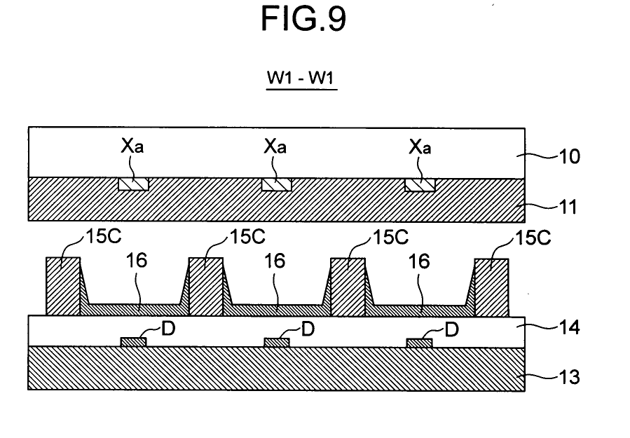

Incidentally, FIG. 6 is a plan view of the PDP 50 as viewed from the front. FIG. 7 is a sectional view of the PDP 50 as viewed from the line V1-V1 shown in FIG. 6. FIG. 8 is a sectional view of the PDP 50 as viewed from the line V2-V2 shown in FIG. 6. FIG. 9 is a sectional view of the PDP 50 as viewed from the line W1-W1 shown in FIG. 6.

As shown in FIG. 6, the row electrode Y is structured by a strip-formed bus electrode Yb (row electrode Y main body) extending horizontally on the display screen and a plurality of transparent electrodes Ya connected to the bus electrode Yb. The bus electrode Yb is formed by a metal film, e.g. in black. The transparent electrodes Ya are made by a transparent conductive film of ITO or the like, and respectively arranged in positions corresponding to the column electrodes D on the bus electrode Yb. The transparent electrode Ya extends in a direction orthogonal to the bus electrode Yb, whose one and the other ends formed wide as shown in FIG. 6. Namely, the transparent electrode Ya can be considered as a projection electrode projecting from the main body of the row electrode Y. Meanwhile, the row electrode X is structured by a strip-formed bus electrode Xb (row electrode X main body) extending horizontally on the display screen and a plurality of transparent electrodes Xa connected to the bus electrode Xb. The bus electrode Xb is formed by a metal film, e.g. in black. The transparent electrodes Xa are made by a transparent conductive film of ITO or the like, and respectively arranged in positions corresponding to the column electrodes D on the bus electrode Xb. The transparent electrode Xa extends in a direction orthogonal to the bus electrode Xb, whose one end is formed wide as shown in FIG. 6. Namely, the transparent electrode Xa can be considered as a projection electrode projecting from the main body of the row electrode X. The wide parts of the transparent electrodes Xa and Ya are arranged opposite to each other through a predetermined width of discharge gap g, as shown in FIG. 6. Namely, the row electrodes X and Y in pair have transparent electrodes Xa and Ya, as projection electrodes projecting from the main bodies thereof, which are oppositely arranged through the discharge gap g.

The row electrode Y made by a transparent electrode Ya and bus electrode Yb and the row electrode X made by a transparent electrode Xa and bus electrode Xb are formed. on a back surface of a front glass substrate 10 to serve as a display surface of PDP 50, as shown in FIG. 7. Furthermore, a dielectric layer 11 is formed on the back surface of the front glass substrate 10 in order to cover the row electrodes X and Y. In the corresponding positions to control discharge cells C2 (referred later) on a surface of the dielectric layer 11, a bulking dielectric layer 12 is formed projecting from the dielectric layer 11 toward the back. The bulking dielectric layer 12 is made by a light absorbing layer in a strip form containing a black or dark-color pigment, and formed extending horizontally on the display surface as shown in FIG. 6. The surface of the bulking dielectric layer 12 and of the dielectric layer 11 where the bulking dielectric layer 12 is not formed is covered by a protection layer (not shown) of MgO (magnesium oxide). On the back substrate 13 arranged parallel with the front glass substrate 10, a plurality of column electrodes D are arranged extending orthogonally (vertically) to the bus electrodes Xa and Xb and in parallel one with another through a predetermined gap. On the back substrate 13, a white column-electrode protection layer (dielectric layer) 14 is formed covering the column electrodes D. On the column-electrode protection layer 14, a division wall 15 is formed by a first lateral wall 15A, a second lateral wall 15B and a longitudinal wall 15C. The first lateral wall 15A is formed extending horizontally on the display surface, in a position opposite to the bus electrode Yb on the column-electrode protection layer 14. The second lateral wall 15B is formed extending horizontally on the display surface, in a position opposite to the bus electrode Xb on the column-electrode protection layer 14. The longitudinal wall 15C is formed extending orthogonally to the bus electrode Xb (Yb), in a position between the transparent electrode Xa (Ya) arranged with the equal gap.

Meanwhile, as shown in FIG. 7, a secondary-electron emitting material layer 30 is formed on the column electrode protection layer 14, in an area opposed to the bulking dielectric layer 12 (including the side faces of the longitudinal wall 15c, first lateral wall 15A and second lateral wall 15B). The secondary-electron emitting material layer 30 is a layer formed of a high Υ material having a high work function (e.g. at 4.2 eV or lower), high in what is called secondary-electron emitting coefficient. The material usable for the secondary-electron emitting material layer 30 includes alkali earth metal oxide such as MgO, CaO, SrO and BaO, alkali metal oxide such as Cs₂O, fluoride such as CaF₂ and MgF₂, TiO₂, Y₂O₃ or a material enhanced in secondary-electron emitting coefficient by crystal defects or impurity doping, diamond-like thin film, carbon nano-tube, and so on. On the other hand, as shown in FIG. 7, a fluorescent layer 16 is formed on the column-electrode protection layer 14, in the area other than the area opposed to the bulking dielectric layer 12 (including the side faces of the longitudinal wall 15c, first lateral wall 15A and second lateral wall 15B). The fluorescent layer 16 includes a red fluorescent layer for causing red light, a green fluorescent layer for causing green light, and a blue fluorescent layer for causing blue light. These are determined in assignment based on each pixel cell PC. There exists a discharge space filled with a discharge gas, between the secondary-electron emitting material layer 30 and fluorescent layer 16 and the dielectric layer 11. The first lateral wall 15A, second lateral wall 15B and longitudinal wall 15C have a height not so high as reaching a surface of the bulking dielectric layer 12 or dielectric layer 11, as shown in FIGS. 7 and 9. Consequently, a gap r exists allowing a discharge gas to pass between the second lateral wall 15B and the bulking dielectric layer 12, as shown in FIG. 7. Between the first lateral wall 15A and the bulking dielectric layer 12, a dielectric layer 17 is formed extending in a direction along the first lateral wall 15A, in order to prevent discharge interference. Also, between the longitudinal wall 15C and the bulking dielectric layer 12, a dielectric layer 18 is formed intermittently in a direction along the longitudinal wall 15C, as shown in FIG. 8.

Herein, the area surrounded by the first lateral wall 15A and the longitudinal wall 15C (the area surrounded by the one-dot chain line in FIG. 6) provides a pixel cell PC to serve as a pixel. Furthermore, as shown in FIGS. 6 and 7, the pixel cell PC is divided by the second lateral wall 15B, into a display discharge cell C1 and a control discharge cell C2. The display discharge cell C1 includes a pair of row electrodes X and Y serving as a display line and a fluorescent layer 16, as shown in FIGS. 6 and 7. Meanwhile, the control discharge cell C2 includes a row electrode Y of the row electrodes in one pair serving as the display line, a row electrode X of the row electrodes in one pair serving as the display line above adjacent to the display line on the display surface, a bulk dielectric layer 12 and a secondary-electron emitting material layer 30. Incidentally, within the display discharge cell C1, there are oppositely arranged a wide part formed at one end of the transparent electrode Xa of the row electrode X and a wide part formed at one end of the transparent electrode Ya of the row electrode Y through a discharge gap g, as shown in FIG. 6. On the other hand, within the control discharge cell C2, there is included a wide part formed at the other end of the transparent electrode Ya but not included a transparent electrode X.

Meanwhile, as shown in FIG. 7, the pixel cells PC vertically adjacent on the display surface (left-right direction in FIG. 7) are shielded in their discharge spaces by the first lateral wall 15A and dielectric layer 17. Nevertheless, the display discharge cell C1 and the control discharge cell C2, belonging to the same pixel cell PC, are communicated with each other in discharge space through the gap r, as shown in FIG. 7. Furthermore, the control discharge cells C2 mutually adjacent in the left-right direction on the display surface are shielded in their discharge spaces by the bulking dielectric layer 12 and dielectric layer 18a as shown in FIG. 8, whereas the display discharge cells C1 mutually adjacent in the left-right direction on the display surface are communicated in their discharge spaces with each other.

In this manner, the pixel cell PC_{1.1}-PC_{n-1,m} formed on the PDP 50 is structured by a display discharge cell C1 and a control discharge cell C2 having respective discharge spaces communicated with each other.

The odd-number X electrode driver 51 applies various drive pulses (referred later) to the odd-numbered (shown in FIG. 5) row electrodes X₁, X₃, X₅, . . . , Xₙ₋₂ and Xₙ, of the row electrodes X of the PDP 50, according to a timing signal supplied from the drive control circuit 56. The even-number X electrode driver 52 applies various drive pulses (referred later) to the even-numbered (shown in FIG. 5) row electrodes X₂, X₄, X₆, . . . , Xₙ₋₃ and Xₙ₋₁ of the row electrodes X of the PDP 50, according to a timing signal supplied from the drive control circuit 56. The odd-number Y electrode driver 53 applies various drive pulses (referred later) to the odd-numbered (shown in FIG. 5) row electrodes Y₃, Y₅, . . . , Yₙ₋₂ and Yₙ of the row electrodes Y of the PDP 50, according to a timing signal supplied from the drive control circuit 56. The even-number Y electrode driver 54 applies various drive pulses (referred later) to the even-numbered (shown in FIG. 5) row electrodes Y₂, Y₄, . . . , Yₙ₋₃ and Yₙ₋₁ of the row electrodes Y of the PDP 50, according to a timing signal supplied from the drive control circuit 56. The address driver 55 applies a pixel data pulse (referred later) to the column electrodes D₁-Dₘ of the PDP 50, according to a timing signal supplied from the drive control circuit 56.

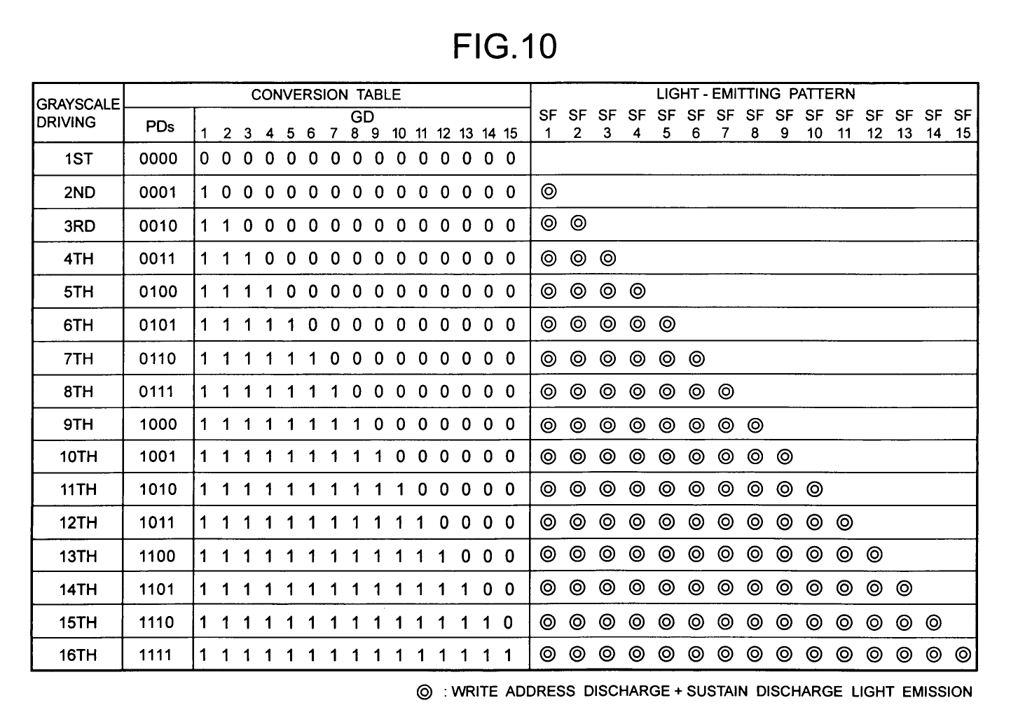

The drive control circuit 56 first converts an input video signal into, for example, 8-bit pixel data representative of a luminance level on each pixel, and carries out error-diffusion process and dither process on the pixel data. For example, in the error-diffusion process, at first pixel data is taken higher 6 bits as display data and the remaining lower 2 bits as error data. The weighted addition of error data on the relevant pixel data corresponding to each of peripheral pixels is reflected in the display data. By this operation, the luminance of lower 2 bits on an original pixel is artificially expressed by the peripheral pixels. Accordingly, by 6-bit image data less than 8 bits, luminance tonal representation is made available equivalent to that of 8-bit pixel data. Dither process is carried out on the 6-bit error-diffusion-processed pixel data. In the dither process, a plurality of mutually adjacent pixels are taken as one pixel unit, so that dither coefficients of mutually different coefficient values are respectively assigned in those of error-diffusion-processed pixel data corresponding to the pixels of one pixel unit and added together, thereby obtaining dither-addition pixel data. With dither-coefficient addition, where viewed based on the one-pixel unit, the dither-addition pixel data only in higher 4 bits can express a luminance corresponding to that of 8 bits. For this reason, the drive control circuit 56 takes the higher four bits of dither-addition pixel data as multi-gradation pixel data PDs. This is converted into 15-bit pixel drive data GD comprising the 1st to 15th bits, according to a data conversion table as shown in FIG. 10. Accordingly, the pixel data for representing 256 tonal levels on 8 bits is converted into 15-bit pixel drive data GD comprising 16 patterns in total, as shown in FIG. 10. Then, the drive control circuit 56 separates these of pixel drive data GD_{1.1}-GD(ₙ₋₁),m between the same bit figures, based on one screen of pixel drive data GD_{1.1}-GD_{(n-1),m}. As a result, pixel-drive data bit groups DB1-DB15 are obtained as follows:

DB1: first bit in each of pixel-drive data GD_{1.1}-GD_{(n-1),m}

DB2: second bit in each of pixel-drive data GD_{1.1}-GD_{(n-1),m}

DB3: third bit in each of pixel-drive data GD_{1.1}-GD_{(n-1),m}

DB4: fourth bit in each of pixel-drive data GD_{1.1}-GD(_{n-1),m}

DB5: fifth bit in each of pixel-drive data GD_{1.1}-GD_{(n-1),m}

DB6: sixth bit in each of pixel-drive data GD_{1.1}-GD_{(n-1),m}

DB7: seventh bit in each of pixel-drive data GD_{1.1}-GD_{(n-1),m}

DB8: eighth bit in each of pixel-drive data GD_{1.1}-GD_{(n-1),m}

DB9: ninth bit in each of pixel-drive data GD_{1.1}-GD_{(n-1),m}

DB10: tenth bit in each of pixel-drive data GD_{1.1}-GD_{(n-1),m}

DB11: eleventh bit in each of pixel-drive data GD_{1.1}-GD_{(n-1),m}

DB12: twelfth bit in each of pixel-drive data GD_{1.1}-GD_{(n-1),m}

DB13: thirteenth bit in each of pixel-drive data GD_{1.1}-GD_{(n-1),m}

DB14: fourteenth bit in each of pixel-drive data GD_{1.1}-GD_{(n-1),m}

DB15: fifteenth bit in each of pixel-drive data GD_{1.1}-GD_{(n-1),m}

Incidentally, the pixel-driving data bit groups DB1-DB15 correspond respectively to sub-fields SF1-SF15, referred later. The drive control circuit 56, in each sub-field SF1-SF15, supplies a pixel-driving data bit group DB corresponding to the sub-field in an amount of one display line (m in the number) per time to the address driver 55.

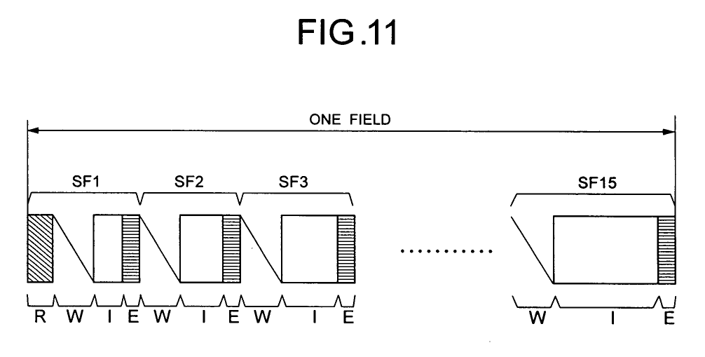

Furthermore, the drive control circuit 56 generates various timing signals to control the drive to the PDP 50, according to a light-emitting drive sequence as shown in FIG. 11, and supplies those to the odd-number X electrode driver 51, the even-number X electrode driver 52, the odd-number Y electrode driver 53 and the even-number Y electrode driver 54.

In the light-emitting drive sequence shown in FIG. 11, each field of video signal is divided into fifteen sub-fields SF1-SF15, to execute an address process W, light-emission maintaining process I and erase process E in each sub-field. Incidentally, in the head sub-field SF1, a simultaneous reset process R is executed in advance of the address process W.

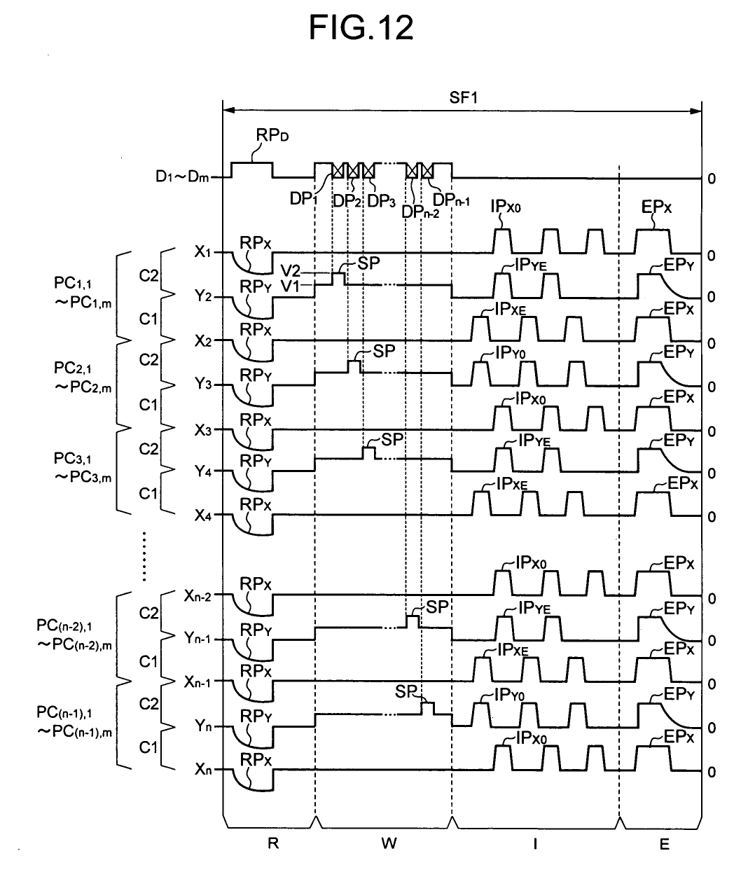

FIG. 12 shows the various drive pulses to be applied in the simultaneous reset process R, address process W, light-emission maintaining process I and erase process E by the odd-number X electrode driver 51, even-number X electrode driver 52, odd-number Y electrode driver 53 and even-number Y electrode driver 54 to the PDP 50. Incidentally, FIG. 12 shows only the head sub-field SF1 by excerption.

At first, in the simultaneous reset process R, the odd-number X electrode driver 51 and even-number X electrode driver 52 generate negative-polarity reset pulses RPₓ moderate in fall change as compared to the sustain pulse (referred later), and apply them simultaneously to the row electrodes X₁-Xₙ of the PDP 50. Simultaneously with application of the reset pulse RPₓ, the odd-number Y electrode driver 53 and even-number Y electrode driver 54 generate negative-polarity reset pulses RP_{y} moderate in fall change as compared to the sustain pulse (referred later), and apply them simultaneously to the row electrodes Y₂-Yₙ of the PDP 50. In this duration, the address driver 55 generates positive-polarity reset pulses RP_{D} and applies them simultaneously to the column electrodes D₁-Dₙ of the PDP 50. In accordance with application of these reset pulses RP_{D}, RP_{Y} and RPₓ, reset discharge (erase discharge) is caused within each control discharge cell C2 of the pixel cell PC_{1.1}-PC_{(n-1),m} of the PDP 50. Incidentally, by applying the reset pulses RP_{D}, RP_{Y} and RPₓ, the column electrode D end is to act as anode relative to the row electrodes X, Y. By the reset discharge, wall charge existing within the control discharge cell C2 in every pixel cell PC is vanished away.

As noted above, in the simultaneous reset process R, wall charge is simultaneously vanished from the control discharge cell C2 of every pixel cell PC of the PDP 50. The pixel cells PC are all initialized to light-off cell mode.

Next, in the address process W, the odd-number Y electrode driver 53 and even-number Y electrode driver 54 apply a scanning pulse SP having a positive-polarity voltage V2 (V2>V1) sequentially to the row electrodes Y₂-Yₙ while applying a positive-polarity voltage V1 to all the row electrodes Y₂-Yₙ. In this duration, the address driver 55 converts the data bits in the pixel-driving data bit group DB1 corresponding to this sub-field SF1 into a pixel data pulse DP having a pulse voltage commensurate with the logic level thereof. For example, the address driver 55 converts, on one hand, a pixel-driving data bit having logic level 0 into a positive-polarity high voltage pixel data, and, on the other hand, a pixel-driving data bit having logic level 1 into a low-voltage (0 volt) pixel data pulse DP. Such a pixel data pulse DP is applied in an amount of one display line (m in the number) per time to the column electrode D₁-Dₘ, synchronously with application timing of the scanning pulse SP. Namely, the address driver 55 first applies the column electrode D₁-Dₘ with a pixel data pulse group DP₁ comprising pixel data pulses DP in the number of m corresponding to the first display line, and then the column electrode D₁-Dₘ with a pixel data pulse group DP₂ comprising pixel data pulses DP in the number of m corresponding to the second display line. On this occasion, write address discharge is caused between the column electrode D and the row electrode Y within the control discharge cell C2 of the pixel cell PC to which is applied a low-voltage (0 volt) pixel data pulse DP together with a scanning pulse SP having a positive-polarity voltage V2. Due to the write address discharge, the discharge moves toward the display discharge cell C1 through the gap r as shown in FIG. 7, to cause a discharge between the row electrodes Y and X within the display discharge cell C1. By the movement of discharge from the control discharge cell C2 to the display discharge cell C1 as noted above, wall charge is formed within the display discharge cell C1. On the other hand, within a control discharge cell C2 of the pixel cell PC to which a scanning pulse SP is applied but a high-voltage pixel data pulse DP is applied, write address discharge as the above is not caused. There is no formation of wall charge within the control discharge cell C2. Accordingly, on this occasion, there is no occurrence of discharge movement from the control discharge cell C2 to the display discharge cell C1. Accordingly, there is no formation of wall charge within the display discharge cell C1.

In this manner, in the address process W, write address discharge is selectively caused in the control discharge cell C2 of each pixel cell PC according to the data bit of pixel-driving data bit group corresponding to the sub-field, thereby forming wall charge. As a result, the pixel cell PC formed with wall charge is set to light on-cell mode while the pixel cell PC not formed with wall charge is set to light-off cell mode.

Next, in the sustain process I, the odd-number Y electrode driver 53 repeats a positive-polarity sustain pulse IP_{Y0} the number of times assigned in the sub-field to which the sustain process I belongs, to apply them to the odd-numbered row electrodes Y₃, Y₅, . . . , Yₙ. In the same timing as each of the sustain pulses IP_{Y0}, the even-number X electrode driver 52 repeats a positive-polarity sustain pulse IP_{XE} the number of times assigned in the sub-field to which the sustain process I belongs, to apply them to the even-numbered row electrodes X₂, X₄, . . . , Xₙ₋₁. Meanwhile, in the sustain process I, the odd-number X electrode driver 51 repeats a positive-polarity sustain pulse IP_{X0} the number of times assigned in the sub-field to which the sustain process I belongs, to apply them to the odd-numbered row electrodes X₁, X₃, X₅, . . . Xₙ. Furthermore, in the sustain process I, the even-number Y electrode driver 54 repeats a positive-polarity sustain pulse IP_{YE} the number of times assigned in the sub-field to which the sustain process I belongs, to apply them to the even-numbered row electrodes Y₂, Y₄, . . . , Yₙ₋₁. Incidentally, the sustain pulse IP_{XE} or IP_{Y0} and the sustain pulse IP_{X0} and IP_{YE} are deviated in application timing from each other, as shown in FIG. 12. Each time the sustain pulse IP_{X0}, IP_{XE}, IP_{Y0} and IP_{YE} is applied, sustain discharge is caused between the transparent electrodes Xa and Ya within the display discharge cell C1 of the pixel cell PC set in the light on-cell mode. By an ultraviolet ray generated by such sustain discharge, excited is the fluorescent layer 16 (red, green or blue florescent layer) formed in the display discharge cell C1, as shown in FIG. 7. Thus, the light corresponding to the fluorescent color is radiated through the front glass substrate 10. Namely, light emission is repeatedly caused by sustain discharge the number of times assigned in the sub-field to which the sustain process I belongs.

As noted above, in the sustain process I, only the pixel cells PC set in the light on-cell mode are caused to emit light the number of times assigned in the sub-field.

In the erase process E to be executed in the last of each sub-field, the odd-number X electrode driver 51 and even-number X electrode driver 52 apply a positive-polarity erase pulse EPₓ as shown in FIG. 12 to all the row electrodes X. Furthermore, the odd-number Y electrode driver 53 and even-number Y electrode driver 54 apply a positive-polarity erase pulse EP_{Y} as shown in FIG. 12 to all the row electrodes Y. By applying these erase pulses EPₓ and EP_{y}, erase discharge is caused between the row electrode Y and the column electrode D within every control discharge cell C2 and between the row electrodes X and Y within every display discharge cell C1. This erases the wall charge remained within every pixel cell PC.

The driving by the simultaneous reset process R, address process W, light-emission maintaining process I and erase process E is executed on the basis of the pixel-driving data GD in 16 combinations as shown in FIG. 10. According to the driving, write address discharge (shown by the double circle in FIG. 10) is caused in the address process W in each of sub-fields in an amount corresponding to an intermediate luminance to express. Namely, the pixel cells PC are set to light on-cell mode in each of the sub-fields continuing in an amount corresponding to the intermediate luminance to express. Light emission is caused by sustain discharge repeatedly the number of times assigned in each of the sub-fields. On this occasion, perceived is a luminance corresponding to the total number of times of light emissions due to sustain discharge caused within one field. Accordingly, with 16 kinds of light emission patterns on driving at first to sixteenth tonal levels as shown in FIG. 10, in the sub-field SF1-SF15 is expressed an intermediate luminance in 16 tonal levels corresponding to the total number of times of sustain discharges to occur in the sub-field shown by the double circle.

Herein, in the plasma display device shown in FIG. 5, the pixel cell PC serving as a pixel for the PDP 50 is configured by a display discharge cell C1 and a control discharge cell C2, as shown in FIGS. 6 and 7. Sustain discharge related to a display image is caused within the display discharge cell C1 while reset and address discharges with light emission not related to a display image is caused mainly within the control discharge cell C2. Within the control discharge cell C2, a bulking dielectric layer 12 is formed comprising a light-absorbing layer containing a black or dark-color pigment in order to prevent the light caused by reset and address discharges from leaking outside through the front glass substrate 10. Accordingly, because the discharge light due to reset and address discharges is cut off by the bulking dielectric layer 12, contrast, particularly dark contrast, can be enhanced on the display image.

Furthermore, within the control discharge cell C2, a secondary-electron emitting material layer 30 is provided on a side close to the back substrate 13, as shown in FIG. 7. The secondary-electron emitting material layer 30 has a Υ characteristic for emitting secondary electrons given favorable upon discharge wherein the forming surface thereof acts as a cathode. In the driving shown in FIG. 12, when causing write address discharge in the address process W, a scanning pulse SP having a positive-polarity voltage V2 is applied to the row electrode Y while a low-voltage (0 volt) pixel data pulse DP is applied to the column electrode D. Namely, by applying a scanning pulse SP having a polarity to place the column electrode D within the control discharge cell C2 in low potential, the column electrode D is rendered as a cathode end during write address discharge. Consequently, the secondary-electron emitting material layer 30 formed within the control discharge cell C2 also acts as a cathode. Secondary electrons are to be favorably emitted from the secondary-electron emitting material layer 30. Accordingly, write address discharge is positively caused within the control discharge cell C2.

Incidentally, in the above embodiment, explanation was on the case applied by so-called the selective write address method to selectively form wall charge within the pixel cells PC during the address process. Alternatively, a selective erase address method may be adopted to selectively erase the wall charge formed in each of the pixel cells PC.

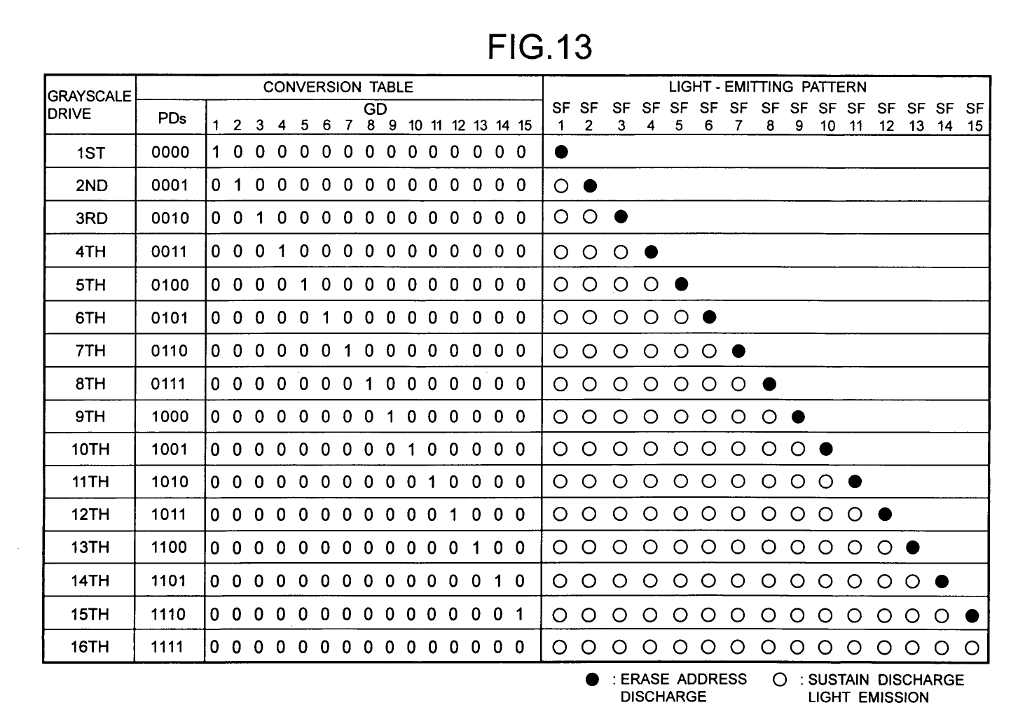

When carrying out driving on a selective erase address method, the drive control circuit 56 first converts an input video signal into 8-bit pixel data representative of a luminance level on each pixel, and carries out error-diffusion process and dither process on the pixel data. By the error-diffusion process and dither process, the drive control circuit 56 converts the 8-bit pixel data into 4-bit multi-gradation pixel data PDₛ, and further converts the multi-gradation pixel data PDₛ into 15-bit pixel drive data GD according to a data conversion table shown in FIG. 13. Due to this, the pixel data capable of representing 256 tonal levels on 8 bits is converted into 15-bit pixel drive data GD comprising 16 patterns in total. Then, the drive control circuit 56 separates these of pixel drive data GD_{1.1}-GD_{(n-1),m} between the same bit figures, based on one screen of pixel drive data GD_{1.1}-GD_{(n-1),m}, thus obtaining pixel-drive data bit groups DB1-DB15. The drive control circuit 56 supplies, based on each sub-field SF1-SF15, a pixel-driving data bit group DB corresponding to the sub-field in an amount of one display line (m in the number) per time to the address driver 55.

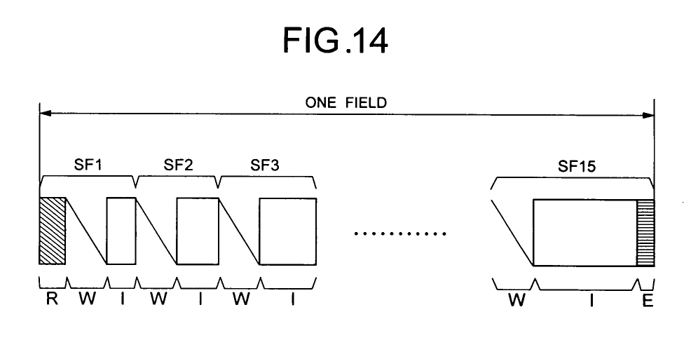

FIG. 14 shows a light-emission driving sequence upon tonally driving the PDP 50 by applying a selective erase address scheme.

In the light-emission driving sequence shown in FIG. 14, the field of video signal is divided into fifteen sub-fields SF1-SF15, to carry out address process W and light-emission maintaining process I in each of the sub-fields. Incidentally, in the head sub-field SF1, simultaneous reset process R is executed in advance of the address process W. In the last sub-field SF15, erase process E is executed immediately after the light-emission maintaining process I.

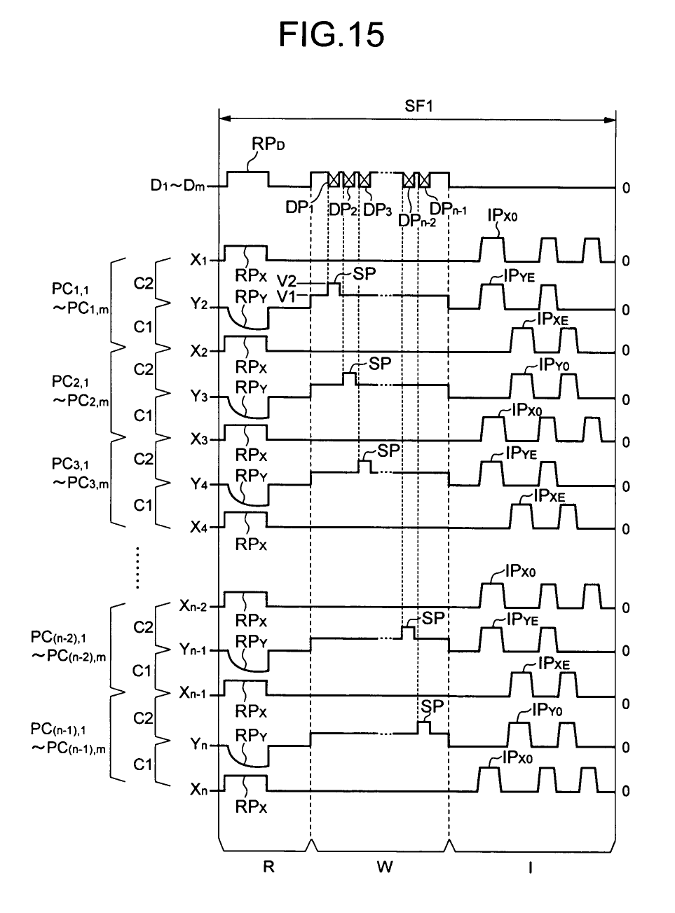

FIG. 15 shows the various drive pulses which the odd-number X electrode driver 51, even-number X electrode driver 52, odd-number Y electrode driver 53 and even-number Y electrode driver 54 apply to the PDP 50 in the simultaneous reset process R, address process W, and light-emission maintaining process I, according to the light-emission driving sequence shown in FIG. 14. Incidentally, FIG. 15 shows only the head sub-field SF1 by excerption.

At first, in the simultaneous reset process R, the odd-number Y electrode driver 53 and even-number Y electrode driver 54 generate negative-polarity reset pulses RP_{y} moderate in fall change as compared to the sustain pulse (referred later), and apply them simultaneously to the row electrodes Y₂-Yₙ of the PDP 50. In the same timing with the reset pulse RP_{Y}, the odd-number X electrode driver 51 and even-number X electrode driver 52 generate positive-polarity reset pulses RP_{X} and apply them simultaneously to the row electrodes X₁-Xₙ of the PDP 50. In this duration, the address driver 55 generates positive-polarity reset pulses RP_{D} and applies them simultaneously to the column electrodes D₁-Dₙ of the PDP 50. In accordance with application of these reset pulses RP_{D}, RP_{y} and RPₓ, reset discharge (write discharge) is caused between the column electrode D and the row electrode Y within the control discharge cell C2 of every pixel cell PC of the PDP 50, thereby forming wall charge within the control discharge cell C2. Incidentally, by applying the reset pulses RP_{D}, RP_{Y} and RPₓ, the column electrode D end is to act as anode relative to the row electrodes X, Y. The reset discharge moves toward the display discharge cell C1 through the gap r as shown in FIG. 7, to cause a discharge between the row electrodes Y and X within the display discharge cell C1. By the movement of discharge, on-wall discharge is formed within the display discharge cell C1 of every pixel cell PC.

As noted above, in the simultaneous reset process R based on the selective erase address scheme, wall charge is formed within the display discharge cell C1 of every pixel cell PC of the PDP 50, thus initializing all the pixel cells PC into light on-cell mode.

Next, in the address process W, the odd-number Y electrode driver 53 and even-number Y electrode driver 54 apply a scanning pulse SP having a positive-polarity voltage V2 (V2>V1) sequentially to the row electrodes Y₂-Yₙ while applying a positive-polarity voltage V1 to all the row electrodes Y₂-Yₙ. In this duration, the address driver 55 converts the data bits in the pixel-driving data bit group DB1 corresponding to this sub-field SF1 into a pixel data pulse DP having a pulse voltage commensurate with the logic level thereof. For example, the address driver 55 converts, on one hand, a pixel-driving data bit having logic level 0 into a positive-polarity high voltage pixel data pulse DP, and, on the other hand, a pixel-driving data bit having logic level 1 into a low-voltage (0 volt) pixel data pulse DP. Such a pixel data pulse DP is applied in an amount of one display line (m in the number) per time to the column electrode D₁-Dₘ, synchronously with application timing of the scanning pulse SP. Namely, the address driver 55 first applies the column electrode D₁-Dₘ with a pixel data pulse group DP₁ comprising pixel data pulses DP in the number of m corresponding to the first display line, and then the column electrode D₁-Dₘ with a pixel data pulse group DP₂ comprising pixel data pulses DP in the number of m corresponding to the second display line. On this occasion, erase address discharge is caused between the column electrode D and the row electrode Y within the control discharge cell C2 of the pixel cell PC to which is applied a low-voltage (0 volt) pixel data pulse DP together with a scanning pulse SP having a positive-polarity voltage V2. Due to the erase address discharge, the discharge moves toward the display discharge cell C1 through the gap r as shown in FIG. 7, to cause discharge between the row electrodes Y and X within the display discharge cell C1. By the movement of discharge from the control discharge cell C2 to the display discharge cell C1 as noted above, the wall charge formed within the display discharge cell C1 is vanished away. On the other hand, within a control discharge cell C2 of the pixel cell PC to which a scanning pulse SP is applied but a high-voltage pixel data pulse DP is applied, erase address discharge as the above is not caused. Accordingly, because there is no occurrence of discharge movement from the control discharge cell C2 to the display discharge cell C1, the forming state of wall charge within the display discharge cell C1 remains in the present situation. Namely, when wall charge exists within the display discharge cell C1, it remains as it is. When it does not exist, the non-formed state of such wall charge is maintained.

In this manner, in the address process W based on the selective erase address scheme, erase address discharge is selectively caused in the control discharge cell C2 of pixel cell PC according to the data bits of pixel-driving data bit group corresponding to the sub-field, thereby erasing wall charge. Due to this, the pixel cell PC where wall charge remains is set to light on-cell mode while the pixel cell PC where wall charge is erased is set to light-off cell mode.

Next, in the sustain process I, the odd-number Y electrode driver 53 repeats a positive-polarity sustain pulse IP_{Y0} the number of times assigned in the sub-field to which the sustain process I belongs, to apply them to the odd-numbered row electrodes Y₃, Y₅, . . . , Yₙ. In the same timing as each of the sustain pulses IP_{Y0}, the even-number X electrode driver 52 repeats a positive-polarity sustain pulse IP_{XE} the number of times assigned in the sub-field to which the sustain process I belongs, to apply them to the even-numbered row electrodes X₂, X₄, . . . , Xₙ₋₁. Meanwhile, in the sustain process I, the odd-number X electrode driver 51 repeats a positive-polarity sustain pulse IP_{X0} the number of times assigned in the sub-field to which the sustain process I belongs, to apply them to the odd-numbered row electrodes X₁, X₃ , X₅ , . . . , Xₙ. Furthermore, in the sustain process I, the even-number Y electrode driver 54 repeats a positive-polarity sustain pulse IP_{YE} the number of times assigned in the sub-field to which the sustain process I belongs, to apply them to the even-numbered row electrodes Y₂, Y₄, . . . , Yₙ₋₁. Incidentally, the sustain pulses IP_{XE} and IP_{Y0} and the sustain pulses IP_{X0} and IP_{YE} are deviated in application timing from each other, as shown in FIG. 15. Each time the sustain pulse IP_{X0}, IP_{XE}, IP_{Y0} or IP_{YE} is applied, sustain discharge is caused between the transparent electrodes Xa and Ya within the display discharge cell C1 of the pixel cell PC set in the light on-cell mode. By an ultraviolet ray generated by such sustain discharge, excited is the fluorescent layer 16 (red, green or blue florescent layer) formed in the display discharge cell C1, as shown in FIG. 7. Thus, the light corresponding to the fluorescent color is radiated through the front glass substrate 10. Namely, light emission repeatedly occurs due to sustain discharge the number of times assigned in the sub-field to which the sustain process I belongs.

As noted above, in the sustain process I, only the pixel cells PC set in the light on-cell mode are caused to emit light the number of times assigned in the sub-field.

The driving based on the simultaneous reset process R, address process W, and light-emission maintaining process is executed on the basis of the pixel-driving data GD in 16 combinations as shown in FIG. 13. Incidentally, according to the driving applied with the selective erase address scheme shown in FIGS. 14 and 15, among the sub-fields SF1-SF11, the pixel cell PC can be transited from light-off cell mode to light on-cell mode only on the occasion of simultaneous reset process R in the sub-field SF1. Consequently, erase address discharge is caused in one sub-field of the sub-fields SF1-SF15. Once the pixel cell PC is set in light-off cell mode, this pixel cell PC does not return to light on-cell mode in the subsequent sub-field. Accordingly, with the driving based on pixel-drive data GD in 16 combinations as shown in FIG. 13, pixel cell PC is set to light on-cell mode in the sub-field continuing in an amount corresponding to a luminance to express. Until erase address discharge (shown by black circle) is caused, sustain discharge emission of light (shown by white circle) is carried out continuously in the sustain process I of each sub-field.

By driving as in the above, perceived is a luminance corresponding to the total number of times of discharges caused within one field period. Namely, with 16 kinds of light emission patterns based on driving at first to sixteenth tonal level as shown in FIG. 13, it is possible to express an intermediate luminance at 16 tonal levels corresponding to the total number of times of sustain discharges to be caused in the sub-fields shown by the white circle.

In driving based on the selective erase address scheme as in the above, when causing erase address discharge in the address process W, a scanning pulse SP having a positive-polarity voltage V2 is applied to the row electrode Y while a low-voltage (0 volt) pixel data pulse DP is applied to the column electrode D. In this manner, by placing the column electrode D within the control discharge cell C2 lower in potential than the row electrode Y, the secondary-electron emitting material layer 30 formed in the control discharge cell C2 is to act as a cathode relative to the row electrode Y. Accordingly, when causing erase address discharge, secondary electrons are favorably emitted from the secondary-electron emitting material layer 30, thus positively causing erase address discharge within the control discharge cell C2.

In the above embodiment explained its operation by exemplifying grayscale driving to represent an intermediate luminance in (N+1) tonal levels on the sub-fields in the number of N (fifteen in the embodiment). However, it is similarly applicable to grayscale driving for representing an intermediate luminance in 2_{N} tonal levels on the sub-fields in the number of N.

Meanwhile, although the above embodiment explained the case of driving the display panel having row electrodes X and Y in the arrangement of X, Y, X, Y to act as a display line, it is similarly applicable to a display panel having row electrodes X and Y in an arrangement of X, X, Y, Y, X, X, Y, Y.

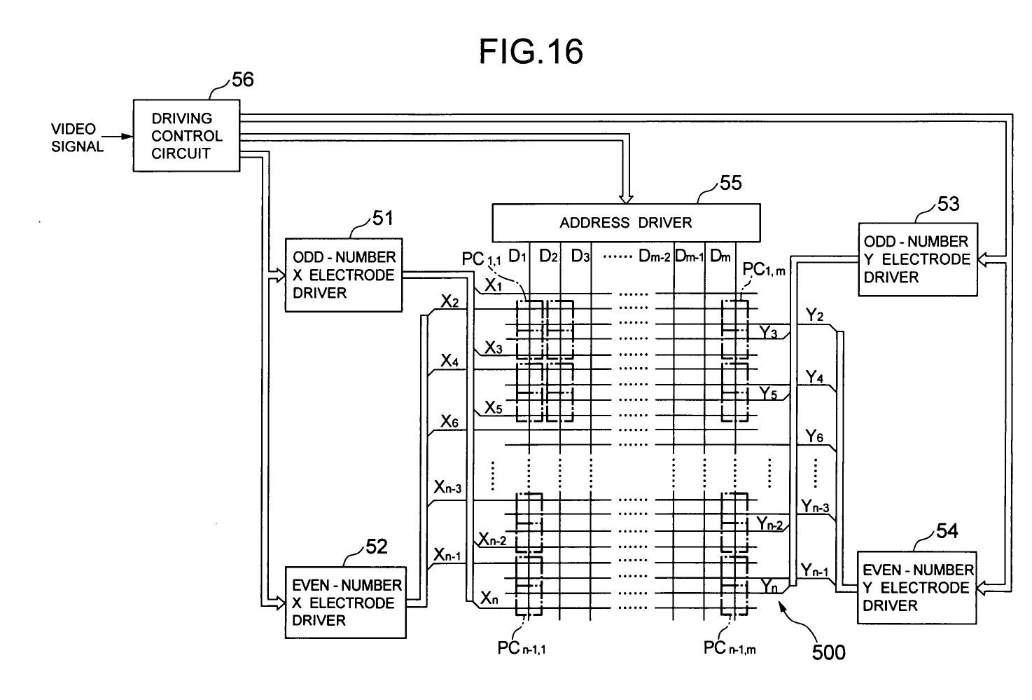

FIG. 16 shows a configuration of a plasma display device mounting a display panel having row electrodes X and Y in an arrangement of X, X, Y, Y, X, X, Y, Y.

As shown in FIG. 16, the plasma display device employs a PDP 500 having row electrodes X and Y in an arrangement order of X, X, Y, Y, X, X, Y, Y, in place of the PDP 50 shown in FIG. 5. The other structure is the same as that shown in FIG. 5.

The PDP 500 is formed with strip-formed column electrodes D₁-Dₘ extending vertically on the display screen. Furthermore, the PDP 500 is formed with strip-formed row electrodes X₁-Xₙ and row electrodes Y₂-Yₙ extending horizontally on the display screen, which are arranged alternately in the numerical order. The electrodes in a pair, i.e. row electrode pair (X₂, Y₂)-row electrode pair (Xₙ, Yₙ), are to respectively act as the first to (n−1)-th display lines of the PDP 500. Pixel cells PC, as pixels, are respectively formed at intersections between the display lines and the column electrodes D₁-Dₘ (in areas surrounded by the one-dot chain line in FIG. 16). Namely, the PDP 500 is arranged with pixel cells PC_{1.1}-PC_{1,m} belonging to the first display line, pixel cells PC_{2.1}-PC_{2,m} belonging to the second display line, . . . , pixel cells PC_{n-1.1}-PC_{n-1,m} belonging to the (n−1)-th display line, in a matrix form.

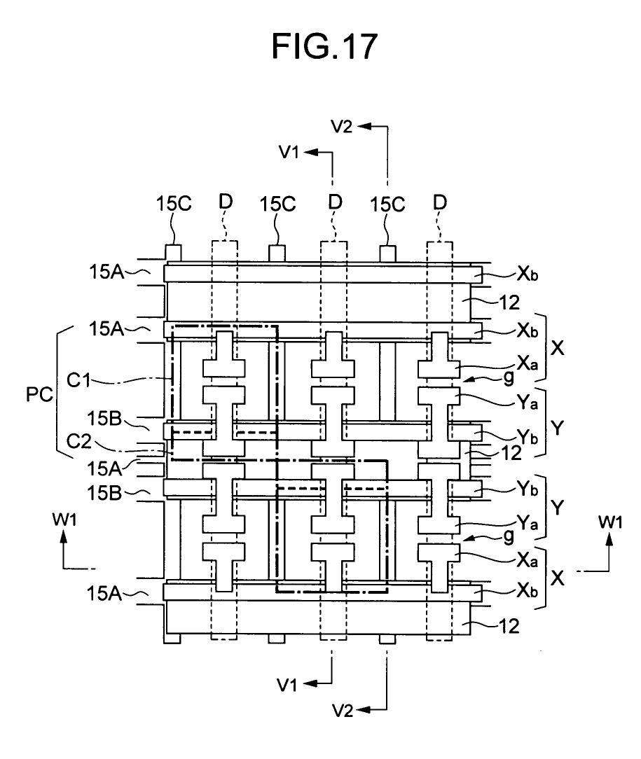

FIGS. 17 to 20 show a part of internal structure of the PDP 500 by excerption.

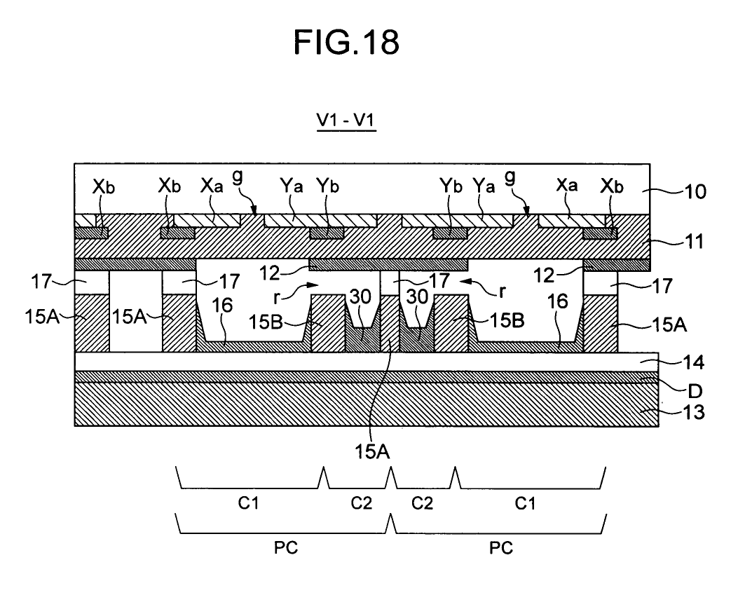

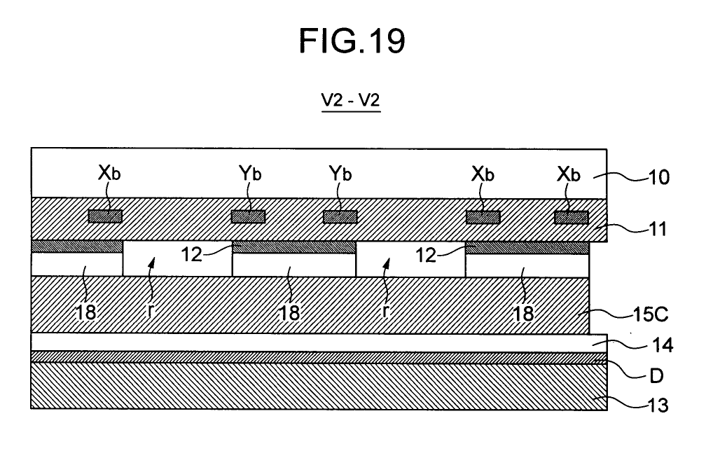

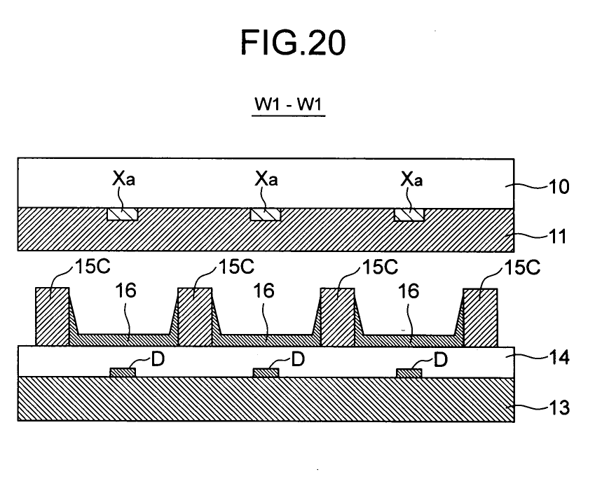

Incidentally, FIG. 17 is a plan view showing a structure as viewed from the front. FIG. 18 is a sectional view as viewed from the line V1-V1 shown in FIG. 17. FIG. 19 is a sectional view as viewed from the line V2-V2. FIG. 20 is a sectional view as viewed from the line W1-W1 shown in FIG. 17. The structural elements denoted by the same numerals as those shown in FIGS. 6 to 9 are the same ones.

Namely, the PDP 500 is formed thereon with pixel cells PC each comprising a pair of discharge cells (display discharge cell C1 and control discharge cell C2) having the same structure as that of the PDP 50, in a matrix form. It is noted that the PDP 500 has control discharge cells C2 arranged respectively of the two pixel cells mutually adjacent vertically on the screen, differently from the PDP 50. The adjacent control discharge cells C2 are shielded in discharge space by a first lateral wall 15A and dielectric layer 17, as shown in FIG. 18.

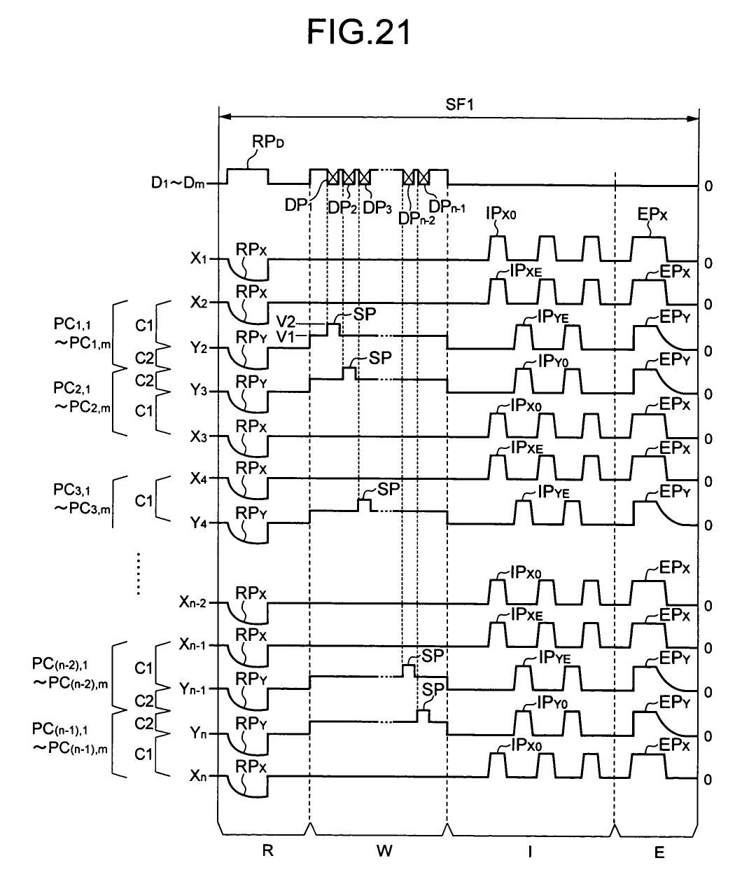

FIG. 21 shows the various drive pulses to be applied to the PDP 500 by the odd-number X electrode driver 51, even-number X electrode driver 52, odd-number Y electrode driver 53 and even-number Y electrode driver 54 when driving the PDP 500 according to a driving sequence as shown in FIGS. 10 and 11 adopting a selective write address scheme.

Incidentally, the reset pulse RPₓ, RP_{y}, RP_{D}, pixel data pulse DP, scanning pulse SP, sustain pulse IP_{X0}, IP_{XE}, IP_{YE}, IP_{Y0}, erase pulses EPₓ and EP_{y} to be applied in a simultaneous reset process R, address process W, sustain process I or erase process E are the same as those shown in FIG. 12. Namely, the discharge to be caused by applying those drive pulses and the operation based on the discharge are the same as those explained in FIG. 12. It is noted that, in the driving shown in FIG. 21, sustain pulses IP_{X0} and IP_{XE} are applied in the same timing to all the row electrodes X in the sustain process I, and further sustain pulses IP_{YE} and IP_{Y0} are applied in the timing different from the IP_{X0} and IP_{XE} to all the row electrodes Y.

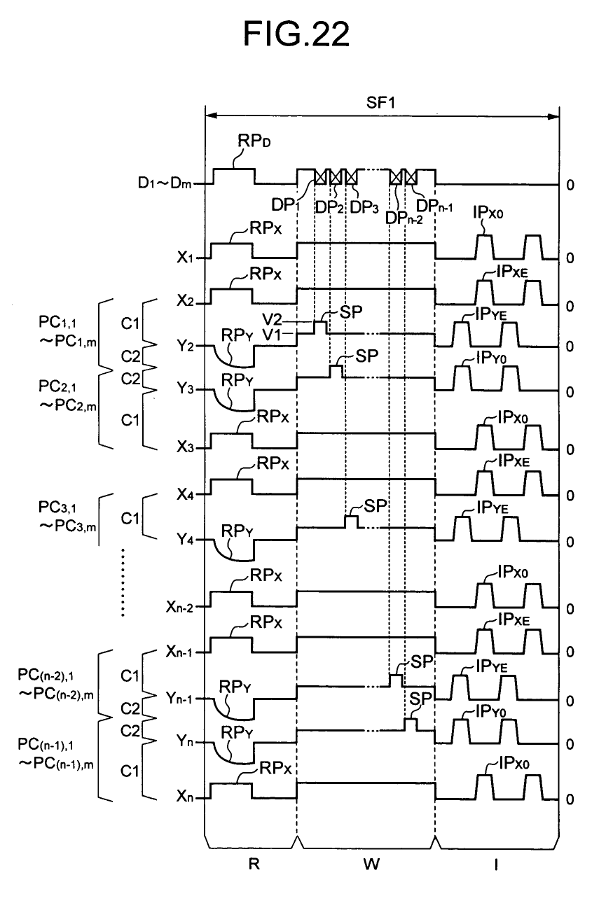

On the other hand, FIG. 22 shows the various drive pulses to be applied to the PDP 500 by the odd-number X electrode driver 51, even-number X electrode driver 52, odd-number Y electrode driver 53 and even-number Y electrode driver 54 when driving the PDP 500 according to a driving sequence as shown in FIGS. 13 and 14 adopting a selective erase address scheme.

Incidentally, the reset pulse RPₓ, RP_{y}, RP_{D}, pixel data pulse DP, scanning pulse SP, sustain pulse IP_{X0}, IP_{XE}, IP_{YE} and IP_{Y0} to be applied in the simultaneous reset process R, address process W and sustain process I are the same as those shown in FIG. 15. Namely, the discharge to be caused by applying those drive pulses and the operation based on the discharge are the same as those explained in FIG. 15. It is noted that, in the driving shown in FIG. 22, sustain pulses IP_{X0} and IP_{XE} are applied in the same timing to all the row electrodes X in the sustain process I, and further sustain pulses IP_{YE} and IP_{Y0} are applied in the timing different from the IP_{X0} and IP_{XE} to all the row electrodes Y.

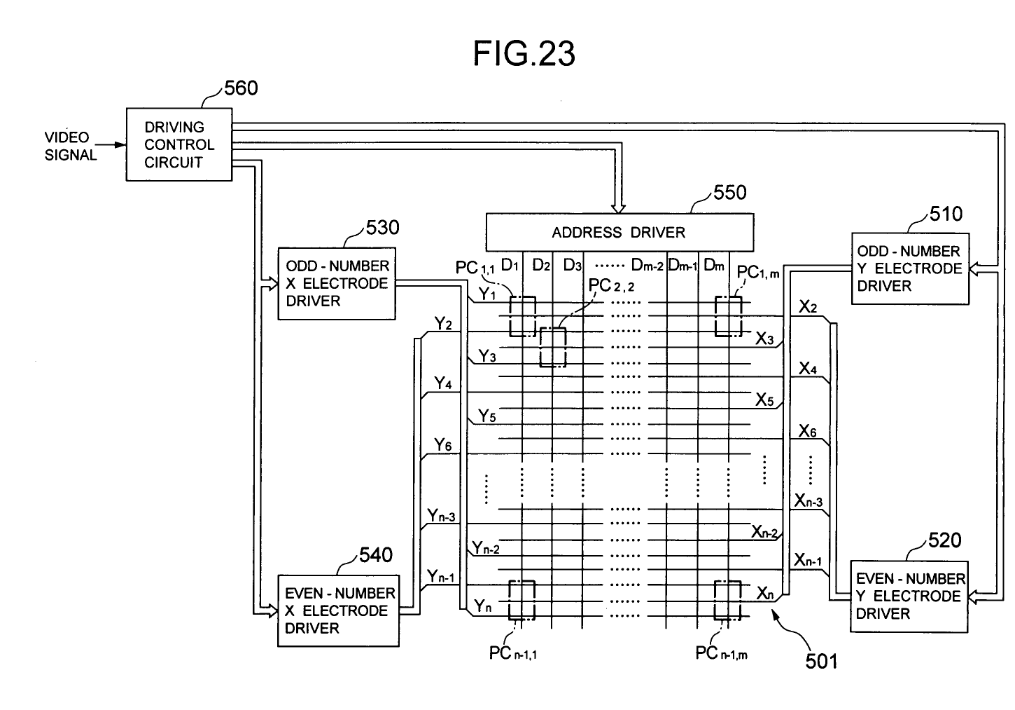

FIG. 23 shows another configuration of a plasma display as a display device.

As shown in FIG. 23, the plasma display is configured with a PDP 501 as a plasma display panel, an odd-number X electrode driver 510, an even-number X electrode driver 520, an odd-number Y electrode driver 530, an even-number Y electrode driver 540, an address driver 550 and a drive control circuit 560.

The PDP 501 is formed with strip-formed column electrodes D₁-Dₘ extending vertically on the display screen. Furthermore, the PDP 501 is formed with strip-formed row electrodes X₂-Xₙ and column electrodes Y₁-Yₙ extending horizontally on the display screen, which are arranged alternately in the numerical order as shown in FIG. 23. The row electrodes in pair, i.e. row electrode pair (X₂, Y₂)-row electrode pair (Xₙ, Yₙ), are respectively to act as the first to (n−1)-th display lines on the PDP 501. Pixel cells PC, as pixels, are respectively formed at intersections between the display lines and the column electrodes D₁-Dₘ (in areas surrounded by the one-dot chain line in FIG. 23). Namely, the PDP 501 is arranged with pixel cells PC_{1.1}-PC_{1,m} belonging to the first display line, pixel cells PC_{2.1}-PC_{2,m} belonging to the second display line, . . . , pixel cells PC_{n-1.1}-PC_{n-1,m} belonging to the (n−1)-th display line, in a matrix form.

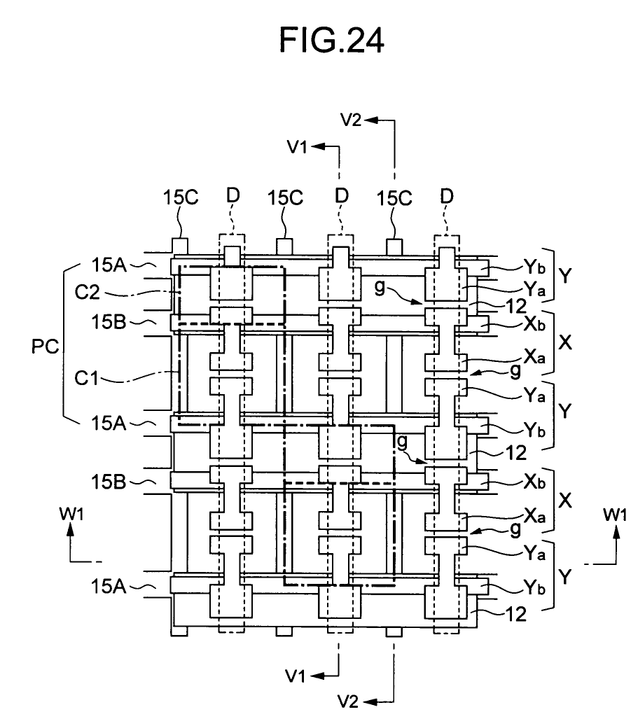

FIGS. 24 to 27 show a part of internal structure of the PDP 501 by excerption.

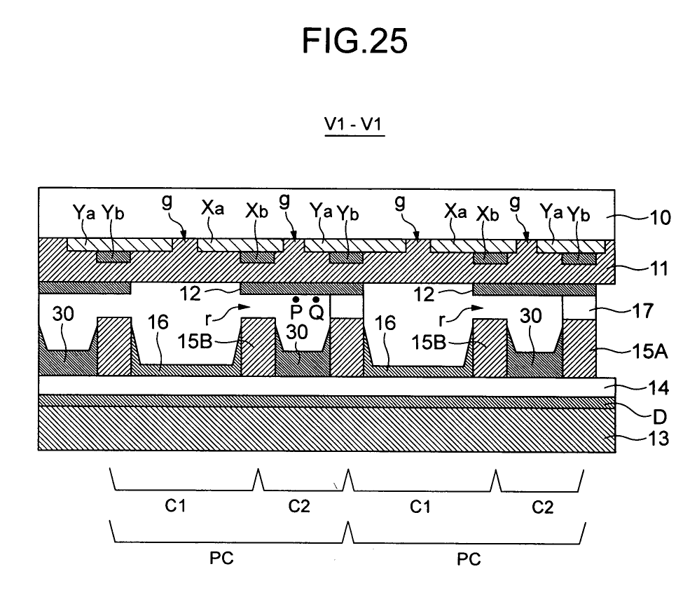

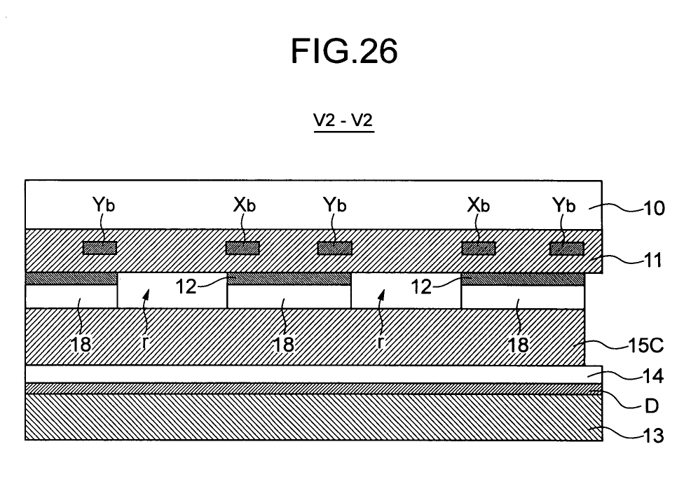

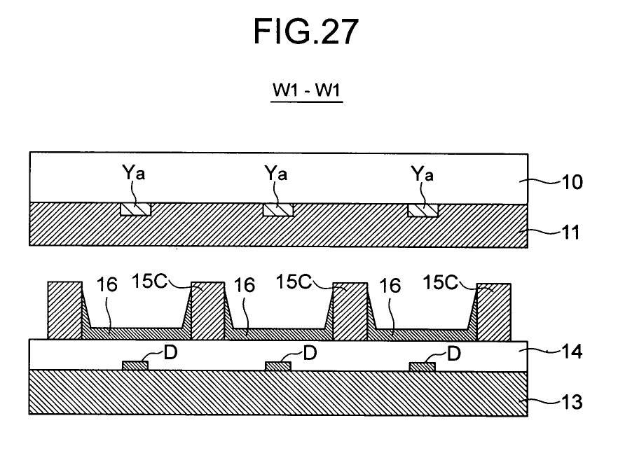

Incidentally, FIG. 24 is a plan view of the PDP 501 as viewed from the front. FIG. 25 is a sectional view as viewed from the line V1-V1 shown in FIG. 24. FIG. 26 is a sectional view as viewed from the line V2-V2 shown in FIG. 24. FIG. 27 is a sectional view of the PDP 501 as viewed from the line W1-W1 shown in FIG. 24. In FIGS. 24 to 27, the structural elements denoted by the same numerals as those shown in FIGS. 6 to 9 are the same ones.

Namely, the PDP 501 is arranged with pixel cells PC each comprising a pair of discharge cells (display discharge cell C1 and control discharge cell C2) having the same structure as that of the PDP 50, in a matrix form. It is noted that, in the PDP 501, the transparent electrode Xa serving as a row electrode X is formed with wide parts at both ends as shown in FIG. 24, differently from the PDP 50. Accordingly, a discharge gap g is also formed between the wide parts of the transparent electrodes Ya and Xa within the control discharge cell C2. Furthermore, the discharge gap g formed within the control discharge cell C2 is formed in a deviated position closer to the display discharge cell C1 which forms a pair with the relevant control discharge cell C2 than the intermediate point between the bus electrodes Xb and Yb formed within the control discharge cell C2.

The odd-number X electrode driver 510 applies various drive pulses (referred later) to the odd-numbered (shown in FIG. 23) row electrodes X₃, X₅, . . . , Xₙ₋₂ and Xₙ of the row electrodes X of the PDP 501, according to a timing signal supplied from the drive control circuit 560. The even-number X electrode driver 520 applies various drive pulses (referred later) to the even-numbered (shown in FIG. 23) row electrodes X₂, X₄, . . . , Xₙ₋₃ and Xₙ₋₁ of the row electrodes X of the PDP 501, according to a timing signal supplied from the drive control circuit 560. The odd-number Y electrode driver 530 applies various drive pulses (referred later) to the odd-numbered (shown in FIG. 23) row electrodes Y₁, Y₃, Y₅, . . . , Yₙ₋₂ and Yₙ of the row electrodes Y of the PDP 501, according to a timing signal supplied from the drive control circuit 560. The even-number Y electrode driver 540 applies various drive pulses (referred later) to the even-numbered (shown in FIG. 23) row electrodes Y₂, Y₄, . . . , Yₙ₋₃ and Yₙ₋₁ of the row electrodes Y of the PDP 501, according to a timing signal supplied from the drive control circuit 560. The address driver 550 applies a pixel data pulse (referred later) to the column electrodes D₁-Dₘ of the PDP 501, according to a timing signal supplied from the drive control circuit 560.

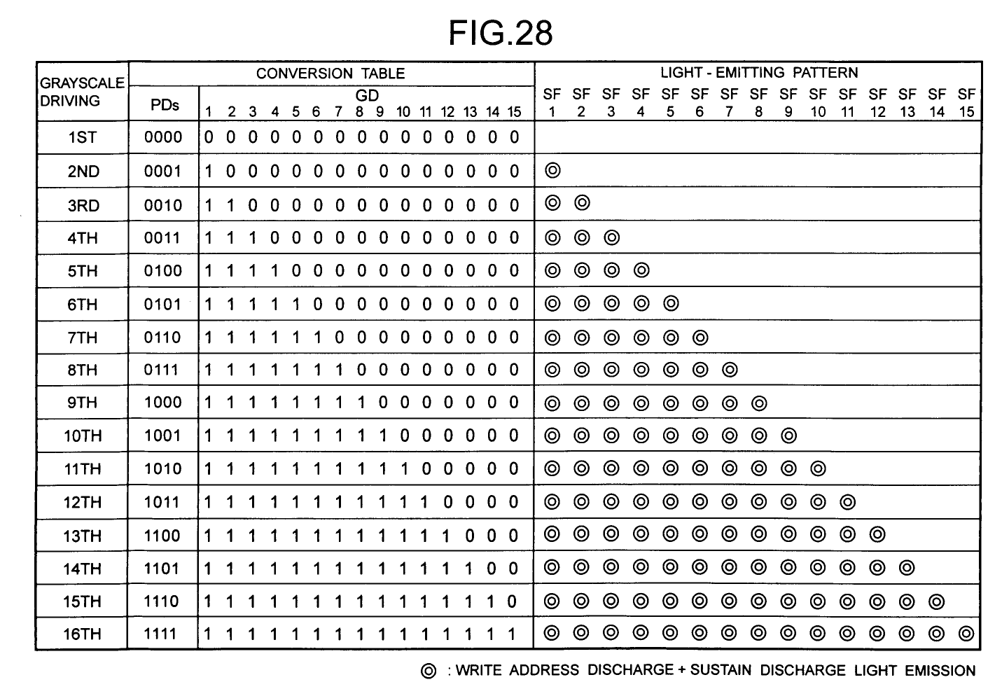

The drive control circuit 560 first converts an input video signal into 8-bit pixel data representative of a luminance level on each pixel, and carries out error-diffusion process and dither process on the pixel data thereby obtaining 4-bit multi-gradation pixel data PDₛ. This is converted into 15-bit pixel driving data GD comprising first to fifteenth bit, according to a data converting table as shown in FIG. 28. Then, the drive control circuit 560 separates these of pixel drive data GD_{1.1}-GD_{(n-1),m} between the same bit figures, based on one screen of pixel drive data GD_{1.1}-GD_{(n-1),m}. Due to this, pixel-drive data bit groups DB1-DB15 are obtained as follows:

DB1: first bit in each of pixel-drive data GD_{1.1}-GD_{(n-1),m}

DB2: second bit in each of pixel-drive data GD_{1.1}-GD_{(n-1),m}

DB3: third bit in each of pixel-drive data GD_{1.1}-GD_{(n-1),m}

DB4: fourth bit in each of pixel-drive data GD_{1.1}-GD_{(n-1),m}

DB5: fifth bit in each of pixel-drive data GD_{1.1}-GD_{(n-1),m}

DB6: sixth bit in each of pixel-drive data GD_{1.1}-GD_{(n-1),m}

DB7: seventh bit in each of pixel-drive data GD_{1.1}-GD_{(n-1),m}

DB8: eighth bit in each of pixel-drive data GD_{1.1}-GD_{(n-1),m}

DB9: ninth bit in each of pixel-drive data GD_{1.1}-GD_{(n-1),m}

DB10: tenth bit in each of pixel-drive data GD_{1.1}-GD_{(n-1),m}

DB11: eleventh bit in each of pixel-drive data GD_{1.1}-GD_{(n-1),m}

DB12: twelfth bit in each of pixel-drive data GD_{1.1}-GD_{(n-1),m}

DB13: thirteenth bit in each of pixel-drive data GD_{1.1}-GD_{(n-1), m}

DB14: fourteenth bit in each of pixel-drive data GD_{1.1}-GD_{(n-1),m}

DB15: fifteenth bit in each of pixel-drive data GD_{1.1}-GD_{(n-1),m}

Incidentally, the pixel-driving data bit groups DB1-DB15 correspond respectively to sub-fields SF1-SF15, referred later. The drive control circuit 560 supplies, based on each sub-field SF1-SF15, a pixel-driving data bit group DB corresponding to the relevant sub-field in an amount of one display line (m in the number) per time to the address driver 550.

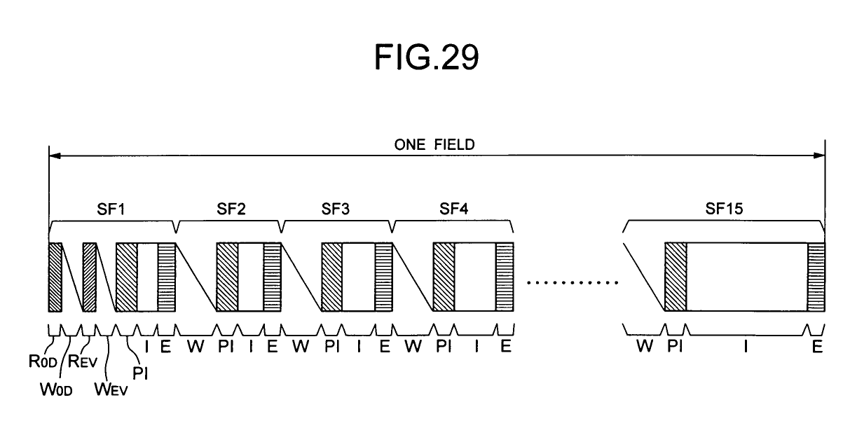

Furthermore, the drive control circuit 560 generates various timing signals for drive-controlling the PDP 501, according to a light-emitting drive sequence as shown in FIG. 29, and supplies those to the odd-number X electrode driver 510, the even-number X electrode driver 520, the odd-number Y electrode driver 530 and the even-number Y electrode driver 540.

In the light-emission driving sequence shown in FIG. 29, the field of video signal is divided into fifteen sub-fields SF1-SF15, to execute the following driving process in each sub-field.

Namely, in the head sub-field SF1, sequentially executed are odd-numbered row reset process R_{OD}, odd-numbered row address process W_{OD}, even-numbered row reset process R_{EV}, even-numbered row address process W_{EV}, priming extension process PI, sustain process I and erase process E. Meanwhile, in each of the sub-fields SF2-SF15, sequentially executed are address process W, priming extension process PI, sustain process I and erase process E.

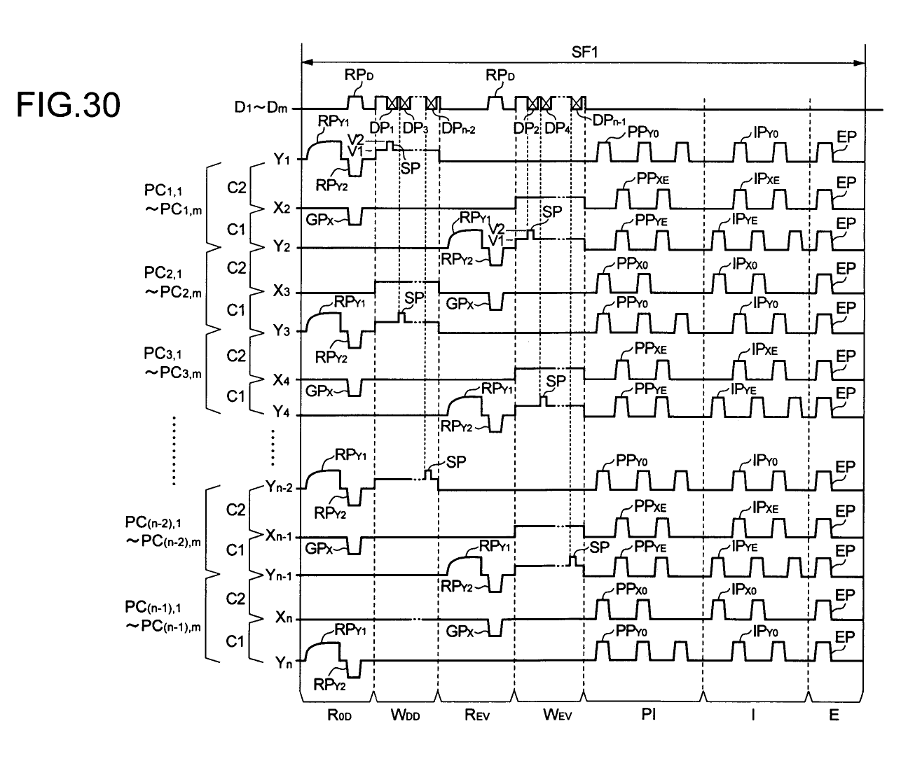

FIG. 30 shows the various drive pulses to be applied to the PDP 501, in the sub-field SF1 shown in FIG. 29, by the odd-number X electrode driver 510, even-number X electrode driver 520, odd-number Y electrode driver 530, even-number Y electrode driver 540 and address driver 550, and application timing thereof.

At first, in the odd-numbered row reset process R_{OD}, the odd-number Y electrode driver 530 generates positive-polarity first reset pulses RP_{Y1} moderate in rise change as compared to the sustain pulse (referred later), and applies them simultaneously to the odd-numbered row electrodes Y₁, Y₃, . . . , Yₙ of the PDP 501. In accordance with applying the first reset pulses RP_{Y1}, first reset discharge (write discharge) is caused between the row electrode Y and the column electrode D within the control discharge cell C2 of every pixel cell PC belonging to the odd-numbered display line. After the first reset pulse RP_{Y1} application, the odd-number Y electrode driver 530 subsequently generates negative-polarity second reset pulse RP_{Y2} and applies them simultaneously to the odd-numbered row electrodes Y₁, Y₃, . . . , Yₙ of the PDP 501. Furthermore, in the same timing as the second reset pulse RP_{Y2}, the address driver 550 generates positive-polarity reset pulse RP_{D} and applies them simultaneously to the row electrodes D₁-Dₙ. In accordance with applying these reset pulse RP_{D} and second reset pulse RP_{Y2}, second reset discharge (erase discharge) is caused between the row electrode Y and the column electrode D within the control discharge cell C2 of each pixel cell PC belonging to the odd-numbered display line. After completing the first reset discharge and the second reset discharge, negative and positive wall charges are respectively formed nearby the column electrode D and nearby the row electrode X and Y within the control discharge cell C2 of every pixel cell PC belonging to the odd-numbered display line.

Then, in the odd-numbered row address process W_{OD}, the odd-number Y electrode driver 530 applies a scanning pulse SP having a positive-polarity voltage V2 (V2>V1) sequentially to the odd-numbered row electrodes Y₁, Y₃, Y₅, . . . , and Yₙ₋₂ while applying a positive-polarity voltage V1 to all the odd-numbered row electrodes Y. In this duration, the address driver 550 converts the pixel-driving data bits corresponding to the odd-numbered display line in the pixel-driving data bit group DB1 corresponding to this sub-field SF1 into a pixel data pulse DP having a pulse voltage commensurate with the logic level thereof. For example, the address driver 550 converts, on one hand, a pixel-driving data bit having logic level 0 into a positive-polarity high voltage pixel data pulse DP, and, on the other hand, a pixel-driving data bit having logic level 1 into a low-voltage (0 volt) pixel data pulse DP. The pixel data pulse DP is applied in an amount of one display line (m in the number) per time to the column electrodes D₁-Dₘ synchronously with application timing of the scanning pulse SP. Namely, the address driver 550 first applies the column electrodes D₁-Dₘ with a pixel data pulse group DP₁ comprising pixel data pulses DP in the number of m corresponding to the first display line, and then the column electrodes D₁-Dₘ with a pixel data pulse group DP₃ comprising pixel data pulses DP in the number of m corresponding to the third display line. On this occasion, write address discharge is selectively caused within the control discharge cell C2 of the pixel cell PC to which is applied a low-voltage (0 volt) pixel data pulse DP together with a scanning pulse SP having a positive-polarity voltage V2. Namely, write address discharge is caused between the column electrode D and the wide part of the transparent electrode Ya within the control discharge cell C2. Meanwhile, within the control discharge cell C2 of the pixel cell PC applied by a high-voltage pixel data pulse DP together with the scanning pulse SP, write address discharge as in the above is not caused. Herein, in the pixel cell PC where write address discharge is caused, negative and positive wall charges are formed respectively nearby the row electrode Y and nearby the row electrode X within the relevant control discharge cell C2. This pixel cell PC is set to temporary light on-cell mode. On the other hand, in the vicinity of the row electrode Y and X within the control discharge cell C2 of the pixel cell PC where write address discharge is not caused, the positive wall charge generated in the odd-numbered row reset process R_{OD} remains as it is. This pixel cell PC is set to light-off cell mode. Incidentally, in the odd-numbered row address process W_{OD}, the odd-number X electrode driver 510 continuously applies the odd-numbered row electrode X with a voltage in the same polarity as the scanning pulse SP, in order to prevent an erroneous discharge between the row electrode D and the column electrode X within the control discharge cell C2.

In this manner, in the odd-numbered address process W_{OD} the pixel cells PC corresponding to the odd-numbered display line are set to either temporary light on-cell mode or light-off cell mode according to the pixel data based on the input video signal.

In the next even-numbered row reset process R_{EV}, the even-number Y electrode driver 540 generates positive-polarity first reset pulses RP_{Y1}, moderate in rise change as compared to the sustain pulse (referred later), and applies them simultaneously to the even-numbered row electrodes Y₂, Y₄, . . . , Yₙ₋₁ of the PDP 501. In accordance with applying the first reset pulse RP_{Y1}, first reset discharge (write discharge) is caused between the row electrode Y and the column electrode D within the control discharge cell C2 of every pixel cell PC belonging to the even-numbered display line. After the first reset pulse RP_{Y1} application, the odd-number Y electrode driver 540 subsequently generates negative-polarity second reset pulse RP_{Y2} and applies them simultaneously to the even-numbered row electrodes Y₂, Y₄, . . . , Yₙ₋₁ of the PDP 501. Furthermore, in the same timing as the second reset pulse RP_{Y2}, the address driver 550 generates positive-polarity reset pulse RP_{D} and applies them simultaneously to the column electrodes D₁-Dₙ. In accordance with applying these reset pulse RP_{D} and second reset pulse RP_{Y2}, second reset discharge (erase discharge) is caused between the row electrode Y and the column electrode D within the control discharge cell C2 of each pixel cell PC belonging to the even-numbered display line. After completing the first reset discharge and the second reset discharge, negative and positive wall charges are respectively formed nearby the column electrode D and nearby the row electrode X and Y within the control discharge cell C2 of every pixel cell PC belonging to the even-numbered display line.

Then, in the even-numbered row address process W_{EV}, the even-number Y electrode driver 540 applies a scanning pulse SP having a positive-polarity voltage V2 (V2>V1) sequentially to the even-numbered row electrodes Y₂, Y₄, Y₆, . . . , Yₙ₋₁ while applying a positive-polarity voltage V1 to all the even-numbered row electrodes Y. In this duration, the address driver 550 converts the pixel-driving data bits corresponding to the odd-numbered display line in the pixel-driving data bit group DB1 corresponding to this sub-field SF1 into a pixel data pulse DP having a pulse voltage commensurate with the logic level thereof. Namely, the address driver 550 converts, on one hand, a pixel-driving data bit having logic level 0 into a positive-polarity high voltage pixel data pulse DP, and, on the other hand, a pixel-driving data bit having logic level 1 into a low-voltage (0 volt) pixel data pulse DP. The pixel data pulse DP is applied in an amount of one display line (m in the number) per time to the column electrodes D₁-Dₘ synchronously with application timing of the scanning pulse SP. Namely, the address driver 550 first applies the column electrodes D₁-Dₘ with a pixel data pulse group DP₂ comprising pixel data pulses DP in the number of m corresponding to the second display line, and then the column electrodes D₁-Dₘ with a pixel data pulse group DP₄ comprising pixel data pulses DP in the number of m corresponding to the fourth display line. On this occasion, write address discharge is selectively caused within the control discharge cell C2 of the pixel cell PC to which is applied a low-voltage (0 volt) pixel data pulse DP together with a scanning pulse SP having a positive-polarity voltage V2. Namely, write address discharge is caused between the column electrode D and the wide part of the transparent electrode Ya within the control discharge cell C2. Meanwhile, within the control discharge cell C2 of the pixel cell PC applied by a high-voltage pixel data pulse DP together with the scanning pulse SP, write address discharge as in the above is not caused.

In the pixel cell PC where write address discharge is caused, negative and positive wall charges are formed respectively nearby the row electrode Y and nearby the row electrode X within the relevant control discharge cell C2. This pixel cell PC is set to temporary light on-cell mode. On the other hand, in the vicinity of the row electrode Y and X within the control discharge cell C2 of the pixel cell PC where write address discharge is not caused, the positive wall charge generated in the even-numbered row reset process R_{EV} remains as it is. This pixel cell PC is set to light-off cell mode. Incidentally, in the even-numbered row address process W_{EV}, the even-number X electrode driver 520 continuously applies the odd-numbered row electrode X with a voltage in the same polarity as the scanning pulse SP, in order to prevent an erroneous discharge between the row electrode D and the column electrode X within the control discharge cell C2.

In this manner, in the even-numbered row address process W_{EV}, the pixel cells PC corresponding to the even-numbered display line are set to either temporary light on-cell mode or light-off cell mode according to the pixel data based on an input video signal.

Incidentally, in the address process W in each of the sub-fields SF2-SF15, the odd-number Y electrode driver 530 and even-number Y electrode driver 540 apply a positive-polarity scanning pulse SP as shown in FIG. 30 sequentially to the row electrodes Y₁, Y₂, Y₃, . . . Yₙ₋₁ (not shown) . In this duration, the address driver 550 converts the pixel-driving data bits in the pixel-driving data bit group DB(j) corresponding to each sub-field SF(j) [j is a natural number of 2-15] into a pixel data pulse DP having a pulse voltage commensurate with the logic level thereof. Such a pixel data pulse DP is applied in an amount of one display line (m in the number) per time to the column electrodes D₁-Dₘ, synchronously with application timing of the scanning pulse SP. On this occasion, write address discharge as noted before is selectively caused within the control discharge cell C2 of the pixel cell PC to which is applied a low-voltage (0 volt) pixel data pulse DP together with the scanning pulse SP. On the other hand, within the control discharge cell C2 of the pixel cell PC to which a high-voltage pixel data pulse DP is applied together with the scanning pulse SP, write address discharge as the above is not caused. In the pixel cell PC where write address discharge is caused, negative and positive wall charges are respectively formed nearby the row electrode Y and nearby the row electrode X within the control discharge cell C2 thereof. This pixel cell PC is set to temporary light on-cell mode. On the other hand, positive wall charge remains nearby the row electrode Y and X within the control discharge cell C2 of the pixel cell PC where write address discharge is not caused. This pixel cell PC is set to light-off cell mode.

Next, in the priming extension process PI, the odd-number Y electrode driver 530 intermittently repeats a positive-polarity priming pulse PR_{Y0} as shown in FIG. 30, to apply them to the odd-numbered row electrodes Y₁, Y₃, . . . , Yₙ. Meanwhile, in the priming extension process PI, the odd-number X electrode driver 510 intermittently repeats a positive-polarity priming pulse PP_{X0} in the same timing as the priming pulse PP_{Y0}, to apply them to the odd-numbered row electrodes X₃, X₅, . . . , Xₙ. Meanwhile, in the priming extension process PI, the even-number X electrode driver 520 intermittently repeats a positive-polarity priming pulse PP_{XE} in different timing from the above PP_{X0} and PP_{Y0} as shown in FIG. 30, to apply them to the even-numbered row electrodes X₂, X₄, . . . , Xₙ₋ₗ. Furthermore, in the priming extension process PI, the even-number Y electrode driver 540 intermittently repeats a positive-polarity priming pulse PP_{YE} in the same timing as the priming pulse PP_{XE} as shown in FIG. 30, to apply them to the even-numbered row electrodes Y₂, Y₄, . . . , Yₙ₋₁. Each time the priming pulse PP_{X0}, PP_{XE}, PP_{Y0} or PP_{YE} is applied, priming discharge is caused between the transparent electrodes Xa and Ya within the control discharge cell C2 of the pixel cell PC set in the temporary light on-cell mode as noted before. On this occasion, whenever priming discharge is caused, discharge extends toward the display discharge cell C1 through the gap r as shown in FIG. 25, forming wall charge within the display discharge cell C1.

As described above, in the priming extension process PI, priming discharge is caused repeatedly only in the control discharge cell C2 of the pixel cell PC set in temporary light on-cell mode in the odd-numbered row address process W_{OD}, even-numbered row address process W_{EV} or address process W, thereby gradually extending discharge toward the display discharge cell C1. Such an extension of the discharge forms wall charge within the display discharge cell C1. The pixel cell PC to which the display discharge cell C1 belongs is set to light on-cell mode. On the other hand, within the control discharge cell C2 set to light-off cell mode in the address process in various kinds, priming discharge is not caused. Accordingly, because wall charge is not formed within the display discharge cell C1 communicating with the relevant control discharge cell C2, the pixel cell C is set to light-off cell mode.

Next, in the sustain process I, the odd-number Y electrode driver 530 repeats a positive-polarity sustain pulse IP_{Y0} as shown in FIG. 30 the number of times assigned in the sub-field to which the sustain process I belongs, thereby applying them to the odd-numbered row electrodes Y₁, Y₃, Y₅, . . . , Yₙ. Meanwhile, in the sustain process I, the even-number X electrode driver 520 generates a positive-polarity sustain pulse IP_{XE} in the same timing as the sustain pulse IP_{Y0} and repeats it the number of times assigned in the sub-field the relevant sustain process I belongs, thereby applying them to the even-numbered row electrodes X₂, X₄, . . . , Xₙ₋₁. Meanwhile, in the sustain process I, the odd-number X electrode driver 510 generates a positive-polarity sustain pulse IP_{X0} as shown in FIG. 30 in the different timing from the sustain pulse IP_{Y0} and repeats it the number of times assigned in the sub-field the relevant sustain process I belongs, thereby applying them to the odd-numbered row electrodes X₁, X₃, X₅, . . . , Xₙ. Meanwhile, in the sustain process I, the even-number Y electrode driver 540 generates a positive-polarity sustain pulse IP_{YE} in the same timing as the sustain pulse IP_{X0} and repeats it the number of times assigned in the sub-field the relevant sustain process I belongs, thereby applying them to the even-numbered row electrodes Y₂, Y₄, . . . , Yₙ₋₁. Each time the sustain pulse IP_{X0}, IP_{XE}, IP_{Y0} or IP_{YE} is applied, sustain discharge is caused between the transparent electrodes Xa and Ya within the display discharge cell C1 of the pixel cell PC set in the light on-cell mode. On this occasion, by an ultraviolet ray generated in such sustain discharge, excited is the fluorescent layer 16 (red, green or blue florescent layer) formed in the display discharge cell C1, as shown in FIG. 27. Thus, the light corresponding to the fluorescent color is radiated through the front glass substrate 10. Namely, light emission repeatedly occurs due to sustain discharge the number of times assigned in the sub-field to which the sustain process I belongs.

In the erase process E, the odd-number X electrode driver 51, even-number X electrode driver 52, odd-number Y electrode driver 53, even-number Y electrode driver 54 and address driver 55 apply a positive-polarity erase pulse EP to all the row electrodes X and Y. In accordance with applying the erase pulses, erase discharge is caused within every control discharge cell C2 where wall charge remains, thus erasing the wall charge.

Herein, in the case executing the driving as shown in FIGS. 29 and 30 on the basis of the pixel-driving data GD in 16 combinations shown in FIG. 28, write address discharge (shown by double circle in FIG. 28) is caused, in each field, in the address processes (W_{OD}, W_{EV}, W) of each of sub-fields continuing in an amount corresponding to an intermediate luminance to express. Namely, the pixel cell PC is set to light on-cell mode in an amount of continuing the sub-fields corresponding to an intermediate luminance to express, to cause sustain discharge in the sustain process I of each of these sub-fields. On this occasion, perceived is the luminance corresponding to the total number of sustain discharges caused within one field. Namely, with 16 kinds of light emission patterns on the first to sixteenth tone driving as shown in FIG. 28, it is possible to express an intermediate luminance in 16 tonal levels depending upon the total number of discharges caused in the sub-fields shown by the double circle.

Herein, in the plasma display device shown in FIG. 23, the pixel cell PC serving as a pixel of the PDP 501 is configured by a display discharge cell C1 and a control discharge cell C2, as shown in FIGS. 24 and 25. Sustain discharge related to a display image is caused within the display discharge cell C1 while reset, priming and address discharges with light emission not related to a display image are caused within the control discharge cell C2. Within the control discharge cell C2, a bulking dielectric layer 12 is formed comprising a light-absorbing layer containing a black or dark-color pigment, in order to prevent the light caused by reset, priming and address discharges caused within the control discharge cell C2 from leaking outside through the front glass substrate 10 on that occasion. Accordingly, because the discharge light caused by reset, priming and address discharges is shielded by the bulking dielectric layer 12, contrast, particularly dark contrast, can be enhanced. Furthermore, within the control discharge cell C2, a secondary-electron emitting material layer 30 is provided on the side close to the back substrate 13, as shown in FIG. 25. With the secondary-electron emitting material layer 30, the discharge start voltage and discharge maintaining voltage between the column electrode D and the row electrode Y within the control discharge cell C2 are lower than the discharge start voltage and discharge maintaining voltage between the column electrode D and the row electrode Y within the display discharge cell C1. Namely, the display discharge cell C1 has higher discharge start voltage and discharge maintaining voltage as compared to the control discharge cell C2. Accordingly, even in the case the priming extension process PI for extending discharge toward the display discharge cell C1 is executed by repeatedly causing priming discharge within the control discharge cell C2, the discharge caused within the display discharge cell C1 is so weak that lowering of dark contrast can be suppressed.

Furthermore, within the control discharge cell C2, the transparent electrodes Xa and Ya projecting from the main parts of the row electrodes X and Y provide a discharge gap g in a position deviated closer to the display discharge cell C1 which forms a pair with the relevant control discharge cell C2 than the intermediate point between the bus electrodes Xb and Yb. Accordingly, by driving as shown in FIG. 30, priming discharge is caused in a position corresponding to the discharge gap g within the control discharge cell C2, e.g. position P shown in FIG. 25. Namely, because priming discharge is caused in a closer position within the control discharge cell C2 to the display discharge cell C1 which forms a pair with the control discharge cell C2, discharge is easily extended from the control discharge cell C2 to the display discharge cell C1. Meanwhile, reset discharge and write address discharges are caused between the column electrode D and the transparent electrode Ya within the control discharge cell C2. Namely, within the control discharge cell C2, reset and write address discharges are caused between the transparent electrode Ya and the row electrode D having a greater distance than the transparent electrode Xa to the display discharge cell C1 which forms a pair with the control discharge cell C2. Consequently, reset and address discharges are caused in a position Q farer from the display discharge cell C1 which forms a pair with this control discharge cell C2 than a position P where priming discharge is caused, as shown in FIG. 25. Accordingly, the ultraviolet ray caused by reset and address discharges is reduced in amount of leaking toward the display discharge cell C1, thereby suppressing lowering of dark contrast.

Meanwhile, by forming a discharge gap within the control discharge cell C2 in a position close to the display discharge cell C1, it is possible to provide the wide part of the transparent electrode Ya facing in the control discharge cell C2 greater in area than the wide part of the transparent electrode Xa facing in the control discharge cell C2. This increases the stability of reset or address discharges caused between the wide parts of the row electrode D and transparent electrode Ya within the control discharge cell C2, thus facilitating the transfer of the discharge in the display discharge cell C1 upon priming discharge.

Incidentally, FIGS. 28 to 30 explained the case applied with so-called the selective write address scheme that, in the address process, wall charge is selectively formed in the pixel cells PC by causing write address discharge. However, selective erase address scheme may be adopted wherein the wall charges formed in the pixel cells PC are selectively erased.

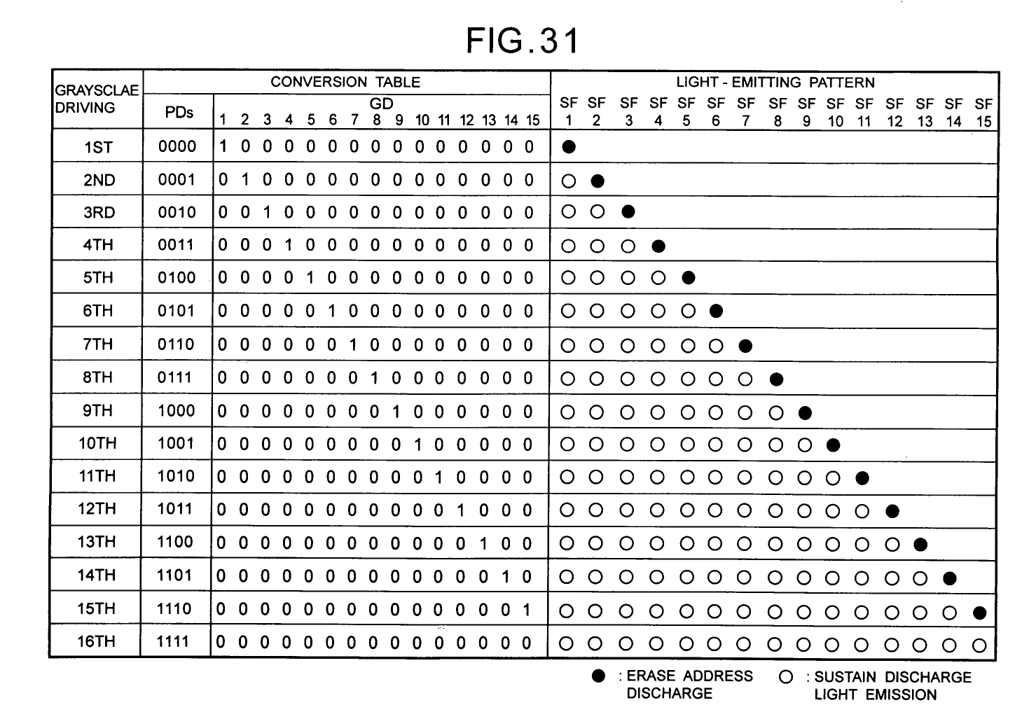

When carrying out driving based on the selective erase address scheme, the drive control circuit 560 first converts an input video signal into 8-bit pixel data representative of a luminance level on each pixel for example, and carries out error-diffusion process and dither process on the pixel data as noted before. By the error-diffusion process and dither process, the drive control circuit 560 converts the 8-bit pixel data into 4-bit multi-gradation pixel data PDₛ, and further converts the multi-gradation pixel data PDₛ into 15-bit pixel drive data GD according to a data conversion table shown in FIG. 31. Then, the drive control circuit 560 separates these of pixel drive data GD_{1.1}-GD_{(n-1),m} between the same bit figures, based on one screen of pixel drive data GD_{1.1}-GD_{(n-1),m} thus obtaining pixel-drive data bit groups DB1-DB15. The drive control circuit 560 supplies, based on each sub-field SF1-SF15, a pixel-driving data bit group DB corresponding to the sub-field in an amount of one display line (m in the number) per time to the address driver 550.

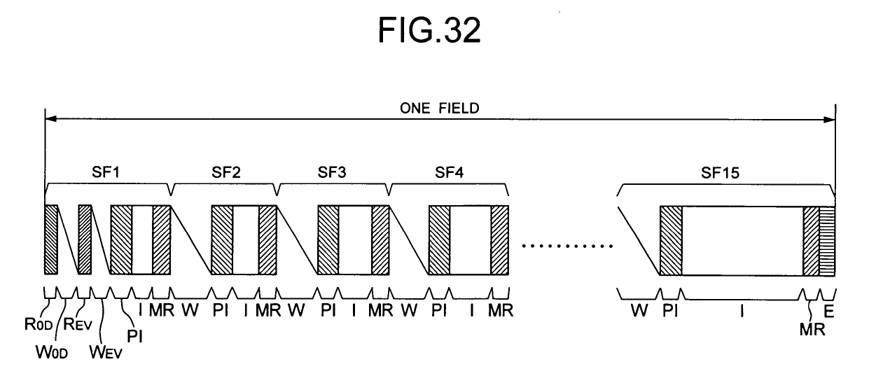

FIG. 32 shows a light-emission driving sequence in tonally driving the PDP 501 by applying a selective erase address scheme.

The light-emission driving sequence shown in FIG. 32 carries out, in the head sub-field SF1, odd-numbered row reset process R_{OD}, odd-numbered row address process W_{OD}, even-numbered row reset process R_{EV}, even-numbered row address process W_{EV}, priming extension process PI, sustain process I and charge moving process MR, in the order. Meanwhile, in each of the sub-fields SF2-SF15, executed are address process W, priming extension process PI, sustain process I and charge moving process MR, in the order. Incidentally, as concerned only with the last sub-field SF15, erase process E is carried out immediately after charge moving process MR.

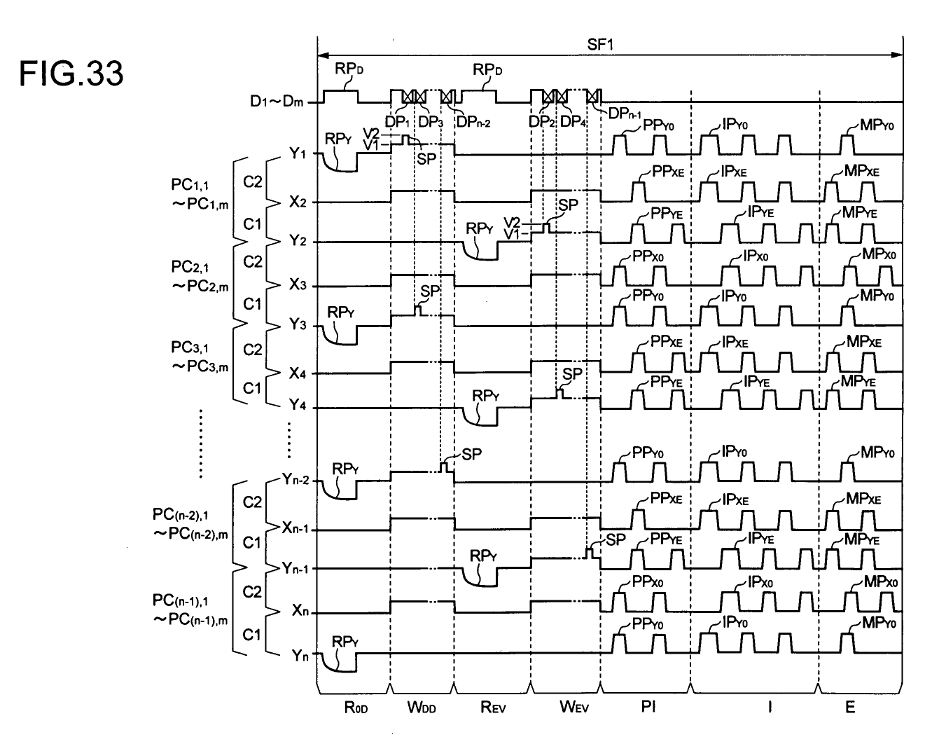

FIG. 33 shows various drive pulses to be applied to the PDP 501 according to a light-emission driving sequence shown in FIG. 32, and the timing of application thereof. Incidentally, FIG. 33 shows only the operation in the sub-field SF1 shown in FIG. 32, by excerption.

At first, in the odd-numbered row reset process R_{OD}, the odd-number Y electrode driver 530 generates negative-polarity reset pulses RP_{Y} moderate in fall change as compared to the sustain pulse (referred later), and applies them simultaneously to the odd-numbered row electrodes Y₁, Y₃, Y₅, . . . , Yₙ of the PDP 501. In this duration, the address driver 550 generates positive-polarity reset pulses RP_{D} and applies them simultaneously to the column electrodes D₁-Dₙ. In accordance with application of these reset pulses RP_{Y} and RP_{D}, reset discharge (write discharge) is caused between the row electrode D and the row electrode Y within each control discharge cell C2 of the pixel cell PC each belonging to the odd-numbered display line. After such reset discharge, negative and positive wall charges are respectively formed nearby the column electrode D and nearby the row electrodes X and Y within the control discharge cell C2 of each of the pixel cells PC belonging to the odd-numbered display line.

Then, in the odd-numbered row address process W_{OD}, the odd-number Y electrode driver 530 applies a scanning pulse SP having a positive-polarity voltage V2 (V2>V1) sequentially to the odd-numbered row electrodes Y₁, Y₃, Y₅, . . . , and Yₙ₋₂ while applying a positive-polarity voltage V1 to all the row electrodes Y. In this duration, the address driver 550 converts the pixel-driving data bits corresponding to the odd-numbered display line in the pixel-driving data bit group DB1 corresponding to this sub-field SF1 into a pixel data pulse DP having a pulse voltage commensurate with the logic level thereof. Namely, the address driver 550 converts, on one hand, a pixel-driving data bit having logic level 0 into a pixel data pulse DP of positive-polarity high voltage, and, on the other hand, a pixel-driving data bit having logic level 1 into a low-voltage (0 volt) pixel data pulse DP. The pixel data pulse DP is applied in an amount of one display line (m in the number) per time to the column electrodes D₁-Dₘ synchronously with application timing of the scanning pulse SP. Namely, the address driver 550 first applies the column electrodes D₁-Dₘ with a pixel data pulse group DP₁ comprising pixel data pulses DP in the number of m corresponding to the first display line, and then the column electrodes D₁-Dₘ with a pixel data pulse group DP₃ comprising pixel data pulses DP in the number of m corresponding to the third display line. On this occasion, erase address discharge is selectively caused within the control discharge cell C2 of the pixel cell PC to which is applied a low-voltage (0 volt) pixel data pulse DP together with a scanning pulse SP having a positive-polarity voltage V2. Namely, erase address discharge is caused between the column electrode D and the wide part of the transparent electrode Ya within the control discharge cell C2. Meanwhile, within the control discharge cell C2 of the pixel cell PC applied by a high-voltage pixel data pulse DP together with the scanning pulse SP, erase address discharge as in the above is not caused. On this occasion, in the pixel cell PC where erase address discharge is caused, negative wall charges are formed respectively nearby the row electrodes Y and X within the relevant control discharge cell C2. This pixel cell PC is set to light-off cell mode. On the other hand, in the vicinity of the row electrodes Y and X within the control discharge cell C2 of the pixel cell PC where erase address discharge is not caused, the positive wall charge generated in the odd-numbered row reset process R_{OD} remains as it is. This pixel cell PC is set to temporary light on-cell mode. Incidentally, in the odd-numbered row address process W_{OD}, the odd-number X electrode driver 510 and even-number X electrode driver 520 continuously apply the row electrode X with a voltage in the same polarity as the scanning pulse SP, in order to prevent an erroneous discharge between the row electrode D and the column electrode X within the control discharge cell C2.

In this manner, in the odd-numbered row address process W_{OD}, the pixel cells PC corresponding to the odd-numbered display line are set to either temporary light on-cell mode or light-off cell mode according to the pixel data corresponding to the input video signal.

Next, in the even-numbered row reset process R_{EV}, the odd-number Y electrode driver 540 generates negative-polarity reset pulses RP_{Y} moderate in fall change as compared to the sustain pulse (referred later), and applies them simultaneously to the even-numbered row electrodes Y₂, Y₄, . . . , Yₙ₋₁ of the PDP 501. In this duration, the address driver 550 generates positive-polarity reset pulse RP_{D} and applies them simultaneously to the column electrodes D₁-Dₙ. In accordance with applying these reset pulses RP_{Y} and RP_{D}, reset discharge (write discharge) is caused between the column electrode D and the row electrode Y within the control discharge cell C2 of each pixel cell PC belonging to the even-numbered display line. After completing the reset discharge, negative and positive wall charges are respectively formed nearby the column electrode D and nearby the row electrodes X and Y within the control discharge cell C2 of each pixel cell PC belonging to the even-numbered display line.

Then, in the even-numbered row address process W_{EV}, the even-number Y electrode driver 540 applies a scanning pulse SP having a positive-polarity voltage V2 (V2>V1) sequentially to the even-numbered row electrodes Y₂, Y₄, Y₆, . . . , Yₙ₋₁ while applying a positive-polarity voltage V1 to all the even-numbered row electrodes Y. In this duration, the address driver 550 converts the pixel-driving data bits corresponding to the even-numbered display line in the pixel-driving data bit group DB1 corresponding to this sub-field SF1 into a pixel data pulse DP having a pulse voltage commensurate with the logic level thereof. Namely, the address driver 550 converts, on one hand, a pixel-driving data bit having logic level 0 into a pixel data pulse DP of positive-polarity high voltage, and, on the other hand, a pixel-driving data bit having logic level 1 into a low-voltage (0 volt) pixel data pulse DP. The pixel data pulse DP is applied in an amount of one display line (m in the number) per time to the column electrodes D₁-Dₘ synchronously with application timing of the scanning pulse SP. Namely, the address driver 550 first applies the column electrodes D₁-Dₘ with a pixel data pulse group DP₂ comprising pixel data pulses DP in the number of m corresponding to the second display line, and then the column electrodes D₁-Dₘ with a pixel data pulse group DP₄ comprising pixel data pulses DP in the number of m corresponding to the fourth display line. On this occasion, erase address discharge is selectively caused within the control discharge cell C2 of the pixel cell PC to which is applied a low-voltage (0 volt) pixel data pulse DP together with a scanning pulse SP having a positive-polarity voltage V2. Namely, erase address discharge is caused between the column electrode D and the wide part of the transparent electrode Ya within the control discharge cell C2. Meanwhile, within the control discharge cell C2 of the pixel cell PC applied by a high-voltage pixel data pulse DP together with the scanning pulse SP, erase address discharge as in the above is not caused. On this occasion, in the pixel cell PC where erase address discharge is caused, negative wall charge is formed nearby the row electrodes X and Y within the relevant control discharge cell C2. This pixel cell PC is set to light-off cell mode. On the other hand, in the vicinity of the row electrodes Y and X within the control discharge cell C2 of the pixel cell PC where erase address discharge is not caused, the positive wall charge generated in the even-numbered row reset process R_{EV} remains as it is. This pixel cell PC is set to temporary light on-cell mode. Incidentally, in the even-numbered row address process W_{EV}, the odd-number X electrode driver 510 and even-number X electrode driver 520 continuously apply all the row electrodes X with a voltage in the same polarity as the scanning pulse SP, in order to prevent an erroneous discharge between the column electrode D and the row electrode X within the control discharge cell C2.

In this manner, in the even-numbered row address process W_{EV}, the pixel cells PC corresponding to the even-numbered display line are each set to either temporary light on-cell mode or light-off cell mode, on the basis of the pixel data corresponding to the input video signal.

Next, in the priming extension process PI, the even-number X electrode driver 520 applies positive-polarity priming pulses PP_{XE} as shown in FIG. 33 respectively to the even-numbered row electrodes X₂, X₄, . . . , Xₙ₋₁. Meanwhile, in the priming extension process PI, the even-number Y electrode driver 540 intermittently repeats a positive-polarity priming pulse PP_{YE} to apply them to the even-numbered row electrodes Y₂, Y₄, . . . , Yₙ₋₂ . and Y₂. Meanwhile, in the priming extension process PI, the odd-number Y electrode driver 530 applies positive-polarity priming pulses PP_{Y0} respectively to the odd-numbered row electrodes Y₁, Y₃, . . . , Yₙ. Furthermore, in the same timing as the priming pulse PP_{Y0}, the odd-number X electrode driver 510 applies positive-polarity priming pulse PP_{X0} to the odd-numbered row electrodes X₃, X₅, . . . , Xₙ. Incidentally, as shown in FIG. 33, application timing is mutually deviated between the priming pulses PP_{X0}, and PP_{Y0} to be applied respectively to the odd-numbered row electrodes X and Y and the priming pulses PP_{XE} and PP_{YE} to be applied respectively to the even-numbered row electrodes X and Y. Herein, each time the priming pulse PP_{X0}, PP_{XE}, PP_{Y0} or PP_{YE} is applied, priming discharge is caused between the transparent electrodes Xa and Ya within the control discharge cell C2 of the pixel cell PC set in the temporary light on-cell mode as noted before. On this occasion, whenever priming discharge is caused, discharge extends toward the display discharge cell C1 through the gap r as shown in FIG. 25, forming wall charge within the display discharge cell C1. The pixel cell PC corresponding to the display discharge cell C1 is set to light on-cell mode. Meanwhile, within the display discharge cell C1 communicating with the control discharge cell C2 where priming. discharge is not caused, wall charge is not formed. Thus, this pixel cell PC is maintained in light-off cell mode.

Next, in the sustain process I, the odd-number Y electrode driver 530 generates a positive-polarity sustain pulse IP_{Y0} as shown in FIG. 33 and repeats it the number of times assigned in the sub-field to which the sustain process I belongs, thereby applying them to the odd-numbered row electrodes Y₁, Y₃, Y₅, . . . , Yₙ. Meanwhile, in the sustain process I, the even-number X electrode driver 520 generates a positive-polarity sustain pulse IP_{XE} in the same timing as the sustain pulse IP_{Y0} and repeats it the number of times assigned in the sub-field the relevant sustain process I belongs, thereby applying them to the even-numbered row electrodes X₂, X₄, . . . , Xₙ₋₁. Meanwhile, in the sustain process I, the odd-number X electrode driver 510 generates a positive-polarity sustain pulse IP_{X0} as shown in FIG. 33 in the different timing from the sustain pulse IP_{XE} and repeats it the number of times assigned in the sub-field the relevant sustain process I belongs, thereby applying them to the odd-numbered row electrodes X₃, X₅, . . . , Xₙ. Furthermore, in the sustain process I, the even-number Y electrode driver 540 generates a positive-polarity sustain pulse IP_{YE} in the same timing as the sustain pulse IP_{X0} and repeats it the number of times assigned in the sub-field the relevant sustain process I belongs, thereby applying them to the even-numbered row electrodes Y₂, Y₄, . . . , Yₙ₋₁. Each time the sustain pulse IP_{X0}, IP_{XE}, IP_{Y0} or IP_{YE} is applied, sustain discharge is caused between the transparent electrodes Xa and Ya within the display discharge cell C1 of the pixel cell PC set in the light on-cell mode. On this occasion, by an ultraviolet ray generated in such sustain discharge, excited is the fluorescent layer 16 (red, green or blue florescent layer) formed in the display discharge cell C1, as shown in FIG. 25. Thus, the light corresponding to the fluorescent color is radiated through the front glass substrate 10. Namely, light emission repeatedly occurs due to sustain discharge the number of times assigned in the sub-field to which the sustain process I belongs.

As described above, in the sustain process I, only the pixel cells PC set in the light on-cell mode in the immediately preceding address process (W_{OD}, W_{EV}, W) are caused to emit light the number of times assigned in the sub-fields.

Next, in the charge moving process MR, the even-number X electrode driver 520 generates a positive-polarity charge moving pulse MP_{XE} and repeats it in order for application onto the even-numbered row electrodes X₂, X₄, . . . , Xₙ₋₁. Meanwhile, the even-number Y electrode driver 540 generates a positive-polarity charge moving pulse MP_{YE} in the same timing as the charge moving pulse MP_{XE} and repeats it in order for application onto the even-numbered row electrodes Y₂, Y₄, . . . , Yₙ₋₁. Meanwhile, in the charge moving process MR, the odd-number Y electrode driver 530 generates a positive-polarity charge moving pulse MP_{Y0} in the different timing from the charge moving pulse MP_{XE} and applies it onto the odd-numbered row electrodes Y₁, Y₃, . . . , Yₙ. Furthermore, in the charge moving process MR, the odd-number X electrode driver 510 generates a positive-polarity charge moving pulse MP_{X0} in the different timing from the charge moving pulse MP_{XE} and applies it onto the odd-numbered row electrodes X₁, X₃, X₅, . . . , Xₙ. Each time the charge moving pulse MP_{X0}, MP_{Y0}, MP_{XE} or MP_{YE} is applied, discharge is caused within the control discharge cell C2 of the pixel cell PC where sustain discharge is caused in the immediately preceding sustain process I. Due to the discharge, the wall charge formed in the display discharge cell C1 which forms a pair with the relevant control discharge cell C2 moves to the control discharge cell C2 through the gap r as shown in FIG. 25.

In the erase process E on the last sub-field SF15, the odd-number X electrode driver 510, even-number X electrode driver 520, odd-number Y electrode driver 530 and even-number Y electrode driver 540 apply a positive-polarity erase pulse to all the row electrodes X and Y (not shown). In accordance with applying the erase pulse, erase discharge is caused within every control discharge cell C2 where wall charge remains, thereby erasing the wall charge.

Herein, according to the driving applied with the selective erase address scheme shown in FIGS. 30-32, among the sub-fields SF1-SF15, the pixel cell PC can be transited from light-off cell mode to light on-cell mode only on the occasion of odd-numbered row reset process R_{OD} and even-numbered row reset process R_{EV}, in the sub-field SF1. Namely, erase address discharge is caused in one sub-field of the sub-fields SF1-SF15. Once the pixel cell PC is set in light-off cell mode, this pixel cell PC does not return to light on-cell mode in the subsequent sub-field. Accordingly, with the driving based on pixel-drive data GD shown in FIG. 31, the pixel cell PC is set to light on-cell mode in each of the sub-fields continuing in an amount corresponding to a luminance to express. Until erase address discharge (shown by black circle) is caused, sustain discharge emission of light (shown by white circle) is carried out continuously in the sustain process I of each sub-field. By such driving, perceived is a luminance corresponding to the total number of times of discharges caused within one field period. Namely, with 16 kinds of light emission patterns based on driving to 16 tonal levels as shown in FIG. 31, in the sub-field shown by white circle is expressed an intermediate luminance at 16 tonal levels corresponding to the total number of times of sustain discharges to occur in the sub-fields.

On this occasion, even in driving applied with a selective erase address scheme as noted before, sustain discharge related to a display image is caused within the display discharge cell C1 while reset, priming and address discharges with light emission not related to a display image is caused within the control discharge cell C2. Accordingly, because the discharge light caused by reset, priming or address discharge is shielded by the bulking dielectric layer 12 formed only in the control discharge cell C2, contrast, particularly dark contrast, can be enhanced in the display image. Furthermore, even in driving applied with a selective erase address scheme, priming discharge is caused between the transparent electrodes Xa and Ya within the control discharge cell C2 while reset and address discharges are caused between the column electrode D and the transparent electrode Ya. Accordingly, because priming discharge is caused in a position close to the display discharge cell C1 which forms a pair with the control discharge cell C2, discharge is easily extended from the control discharge cell C2 to the display discharge cell C1. Meanwhile, reset and address discharges are caused in a position more distant from the display discharge cell C1 than a point where priming discharge is caused, the ultraviolet ray caused by reset and address discharges is reduced in amount of leaking toward the display discharge cell C1, thereby suppressing lowering of dark contrast.

This application is based on Japanese Patent Application No. 2002-346316 which is herein incorporated by reference.

What is claimed is:

1. A display device for carrying out an image display according to pixel data on each pixel on the basis of an input video signal, correspondingly to the input video signal, the display device comprising:
a display panel having
front and back substrates arranged to sandwich a discharge space therebetween;
a plurality of row electrode pairs provided on an inner surface of the front substrate;
a plurality of column electrodes arranged crossing the row electrode pairs on the inner surface of the back substrate; and
unit light-emitting areas, respectively formed at intersections of the row electrode pairs and the column electrodes, each comprising a first discharge cell and a second discharge cell having a light absorbing layer close to the front substrate and a secondary-electron emitting material layer close to the back substrate;
an address component for sequentially applying, while sequentially applying a scanning pulse having a polarity for placing the column electrode in a low potential to first row electrodes of first and second row electrodes constituting the row electrode pairs, a pixel data pulse having a voltage corresponding to the pixel data in an amount of one display line per time to the column electrodes in the same timing as the scanning pulse, thereby selectively causing address discharge within the second discharge cell; and
a sustain component for repetitively applying a sustain pulse alternately to the first row electrodes and the second row electrodes.

2. A display device according to claim 1, wherein the address component includes a component for extending the address discharge toward the first discharge cell thereby setting the first discharge cell in a light on-cell mode, the sustain component applying the sustain pulse alternately to the first row electrode and the second row electrode thereby causing only the first discharge cell in the light on-cell mode to make a sustain discharge repeatedly.

3. A display device according to claim 1, wherein the first discharge cell includes a part where the first row electrode and the second row electrode are opposed through a first discharge gap within the discharge space, the second discharge cell including a part where the second row electrode of the row electrode pair and the first row electrode of a row electrode pair adjacent to the row electrode pair are opposed through a second discharge gap within the discharge space, further including a priming extension component for applying a priming pulse alternately to the first row electrode and the second row electrode within the second discharge cell and causing a priming discharge only in the second discharge cell where the address discharge is caused, thereby extending discharge toward the first discharge cell and setting the first discharge cell to a light on-cell mode.

4. A display device according to claim 3, wherein the second discharge gap is formed in a position deviated closer to the first discharge cell than an intermediate position of the first row electrode and the second row electrode within the second discharge cell.

5. A display device according to claim 3, wherein each of the first and second row electrodes constituting the row electrode pair has a main body extending horizontally on the display panel and projections projecting in a direction crossing the horizontal direction from the main body in each unit light-emitting area, the first discharge cell including a part where the projections of the first and second row electrodes are opposed to each other through the first discharge gap within the discharge space, the second discharge cell including a part where the projection of the second row electrode of the row electrode pair and the projection of the first row electrode of a row electrode pair adjacent to the row electrode pair are opposed to each other through the second discharge gap within the discharge space.

6. A display device according to claim 1, wherein the discharge spaces of the second discharge cells mutually horizontally adjacent on the display panel are closed spaces, and the discharge spaces of the first discharge cells mutually horizontally adjacent on the display panel are communicated with each other.

7. A display device according to claim 1, wherein formed is a fluorescent layer to emit light due to discharge only within the first discharge cell.

8. A display device according to claim 1, further comprising a reset component for applying a reset pulse to between the first row electrode and the column electrode in advance of the address discharge, to thereby cause reset discharge within the second discharge cell.

9. A display device according to claim 8, wherein the reset component is to carry out reset discharge within each of the second discharge cells belonging to an odd-numbered display line of the display panel and reset discharge within each of the second discharge cells belonging to an even-numbered display line of the display panel, separately in time.

10. A display device according to claim 1, wherein the address component is to cause address discharge within each of the second discharge cells belonging to an even-numbered display line of the display panel in different time from address discharge to be caused within each of the second discharge cells belonging to an odd-numbered display line of the display panel.

11. A display device according to any of claims 1 and 8, wherein the reset pulse has a waveform having a moderate level transition in a rise section or fall section as compared to the sustain pulse.

12. A display device according to claim 2, further including an erase component for applying an erase pulse to the first and second row electrodes after completing the sustain discharge, thereby causing erase discharge within the first discharge cell.

13. A display device according to claim 2, further including a charge moving component for applying a charge moving pulse to between the second row electrode of the row electrode pair formed within the second discharge cell and the second row electrode of a row electrode pair adjacent to the row electrode pair after completing the sustain discharge, to cause discharge only within the second discharge cell which forms a pair with the first discharge cell where the sustain discharge is caused, whereby wall charge is moved from the first discharge cell to the second discharge cell thus placing the second discharge cell in an on-cell state.

14. A display device according to claim 1, wherein the unit light-emitting area is demarcated in range by a division wall, the first discharge cell and the second discharge cell within the unit light-emitting area being demarcated by a partition wall.

15. A display device according to claim 14, wherein the second discharge cell within the unit light-emitting area and a unit light-emitting area adjacent to the unit light-emitting area are in closure, and a discharge space of the first discharge cell within the unit light-emitting area and a discharge space of the second discharge cell are in communication.

16. A display device according to claim 1, wherein the first discharge cell has a part where the first row electrode and the second row electrode are opposed through a first discharge gap within the discharge space, the second discharge cell including a part where the first row electrode of the row electrode pair and the second row electrode of a row electrode pair adjacent to the row electrode pair are opposed through a second discharge gap within the discharge space.

17. A display device according to claim 1, wherein the first discharge cell has a part where the first row electrode and the second row electrode are opposed through a first discharge gap within the discharge space, the second discharge cell including a part where the first row electrode of the row electrode pair and the column electrode are opposed through a third discharge gap within the discharge space.
